(19) United States
(12) Patent Application Publication
(10) Pub. No.: US 2026/0133523 A1
(43) Pub. Date: May 14, 2026

(54) DEVELOPING UNIT

(71) Applicant: CANON KABUSHIKI KAISHA, Tokyo (JP)

(72) Inventor: Yuji Ohkubo, Ibaraki (JP)

(21) Appl. No.: 19/372,384

(22) Filed: Oct. 29, 2025

(30) Foreign Application Priority Data
Nov. 11, 2024 (JP) 2024-196680

(51) Int. Cl. G03G 15/08; G03G 21/10

(52) U.S. Cl. CPC G03G 15/0898; G03G 15/0812; G03G 15/0818; G03G 15/0891; G03G 21/105; G03G 2215/0607; G03G 2215/0827; G03G 2221/0005

(57) ABSTRACT

A developing unit includes a developer container, a rotatable developing member, a magnet provided inside the rotatable developing member, and a duct portion including a suction port, a first duct wall and a second duct wall. P1 is located downstream of P2 and upstream of P3. P1 is a point at which a line connecting the rotation center of the rotatable developing member and a distal end of the first duct wall intersects the outer peripheral surface of the rotatable developing member. Fθ≥0 is satisfied over a range from P1 to P3 in the rotation direction of the rotatable developing member. Fθ is a magnetic force in a tangential direction with respect to the outer peripheral surface of the rotatable developing member in a magnetic force acting on the carrier on the outer peripheral surface of the rotatable developing member.

### BACKGROUND

### Field of the Technology

The present disclosure relates to a developing unit that develops an electrostatic latent image formed on an image bearing member using a developer.

### Description of the Related Art

An image forming apparatus such as a copying machine, a printer, a facsimile machine, or a multifunction peripheral includes a developing unit that causes a developer to adhere to an electrostatic latent image formed on a photosensitive drum and develops the electrostatic latent image into a toner image. As the developer, a two-component developer including toner and carrier is widely used. In the developing unit, the amount of developer carried on a developing sleeve is regulated by a regulating member, and thereafter, the developer fed to a developing region facing the photosensitive drum as a developing roller rotates is used to develop the electrostatic latent image on the photosensitive drum into the toner image in the developing region. Therefore, in the developing unit, the toner is likely to be scattered as the developer is fed by the rotating developing sleeve.

When the toner is scattered, the scattered toner is accumulated in the vicinity of the developing unit and the photosensitive drum. Thereafter, if the accumulated toner falls onto the developing sleeve or the photosensitive drum due to vibration during image formation or maintenance, an image defect may occur. US 2021/0096500 A1 discloses a developing unit including a suction duct that sucks scattered toner in order to collect the scattered toner and discharge the toner out of the unit.

Here, in order for the suction duct to effectively suck the scattered toner, it is desirable to arrange a suction port in the vicinity of the developing sleeve. In this arrangement, in the vicinity of the suction port, air sucked into the duct reaches the surface of the developing sleeve and collides with the carrier carried on the surface of the developing sleeve. Due to the collision of the air, the carrier may be separated from the developing sleeve, and may be sucked into the suction duct together with the scattered toner. When the carrier reaches a suction path of the suction duct, the carrier is deposited in the suction path, narrowing the cross-sectional area of the flow path, thereby not obtaining a required air flow rate. As a result, the scattered toner cannot be sufficiently sucked. In addition, in a case where a filter for collecting toner is mounted in the suction duct path, the filter may be clogged with the carrier, thereby reducing the suction force, and the scattered toner cannot be sufficiently sucked, which may lead to a situation in which image defects occur on a daily basis. The duct suction path is difficult to clean, which may lead to a situation in which scattered toner is insufficiently sucked and accordingly image defects occur on a daily basis.

US 2021/0096500 A1 discloses a configuration in which a recess is formed on a lower surface of the suction duct path and carrier is collected by the recess in order to prevent the carrier that has entered when scattered toner is sucked by the suction duct from entering a main body. However, particularly under the use condition in which the image forming apparatus is operated at a high speed, the amount of carrier separated from the developing sleeve tends to increase, and the recess may be filled with the carrier and the carrier may overflow from the recess. Then, the carrier having overflowed from the recess enters the suction path and is deposited in the suction path, and the scattered toner cannot be sufficiently sucked, resulting in a situation in which image defects occur on a daily basis.

### SUMMARY

One aspect of the present disclosure is to suppress suction of carrier into a duct portion.

According to a first aspect of the present disclosure, a developing unit includes a developer container configured to contain a developer including toner and carrier, a rotatable developing member configured to carry and feed the developer to a developing position where an electrostatic latent image formed on an image bearing member is developed, a regulating portion configured to regulate an amount of developer carried on an outer peripheral surface of the rotatable developing member, a magnet provided non-rotatably and stationarily inside the rotatable developing member, the magnet including a regulating pole disposed to face the regulating portion, a first feeding pole disposed downstream of the regulating pole in a rotation direction of the rotatable developing member, a second feeding pole disposed adjacent to the first feeding pole and downstream of the first feeding pole in the rotation direction of the rotatable developing member, and having a polarity different from that of the first feeding pole, and a developing pole disposed downstream of the second feeding pole in the rotation direction of the rotatable developing member, and facing the image bearing member at the developing position, and, a duct portion including a suction port that is an inlet through which the developer scattered in the developer container is sucked, and extending upstream in the rotation direction of the rotatable developing member from the suction port, a first duct wall disposed to face the rotatable developing member, and a second duct wall disposed to face the rotatable developing member and face the first duct wall, and configured to form a space between the second duct wall and the first duct wall through which the developer sucked from the suction port flows, the second duct wall being located outside the first duct wall with respect to a rotation center of the rotatable developing member in a radial direction of the rotatable developing member. In the rotation direction of the rotatable developing member, the suction port is located upstream of a point on the outer peripheral surface of the rotatable developing member at which an absolute value of a magnetic flux density of the developing pole in a normal direction with respect to the outer peripheral surface of the rotatable developing member becomes a maximum value and downstream of a point on the outer peripheral surface of the rotatable developing member at which an absolute value of a magnetic flux density of the regulating pole in the normal direction with respect to the outer peripheral surface of the rotatable developing member becomes a maximum value. P1 is located downstream of P2 and upstream of P3 in the rotation direction of the rotatable developing member. P1 is a point at which a line connecting the rotation center of the rotatable developing member and a distal end of the first duct wall on a suction port side intersects the outer peripheral surface of the rotatable developing member. P2 is a point on the outer peripheral surface of the rotatable developing member at which an absolute value of a magnetic flux density of the first feeding pole in the normal direction with respect to the outer peripheral surface of the rotatable developing member becomes a maximum value. P3 is a point on the outer peripheral surface of the rotatable developing member at which an absolute value of a magnetic flux density of the second feeding pole in the normal direction with respect to the outer peripheral surface of the rotatable developing member becomes a maximum value. Fθ≥0 is satisfied over a range from P1 to P3 in the rotation direction of the rotatable developing member. Fθ is a magnetic force in a tangential direction with respect to the outer peripheral surface of the rotatable developing member in a magnetic force acting on the carrier on the outer peripheral surface of the rotatable developing member. A direction of Fθ from P1 toward P3 in the rotation direction of the rotatable developing member is defined as positive.

According to a second aspect of the present disclosure, a developing unit includes a developer container configured to contain a developer including toner and carrier, a rotatable developing member configured to carry and feed the developer to a developing position where an electrostatic latent image formed on an image bearing member is developed, a regulating portion configured to regulate an amount of developer carried on an outer peripheral surface of the rotatable developing member, a magnet provided non-rotatably and stationarily inside the rotatable developing member, the magnet including a regulating pole disposed to face the regulating portion, a first feeding pole disposed downstream of the regulating pole in a rotation direction of the rotatable developing member, a second feeding pole disposed adjacent to the first feeding pole and downstream of the first feeding pole in the rotation direction of the rotatable developing member, and having a polarity different from that of the first feeding pole, and a developing pole disposed downstream of the second feeding pole in the rotation direction of the rotatable developing member, and facing the image bearing member at the developing position, and, a duct portion including a suction port that is an inlet through which the developer scattered in the developer container is sucked, and extending upstream in the rotation direction of the rotatable developing member from the suction port, a first duct wall disposed to face the rotatable developing member, and a second duct wall disposed to face the rotatable developing member and face the first duct wall, and configured to form a space between the second duct wall and the first duct wall through which the developer sucked from the suction port flows, the second duct wall being located outside the first duct wall with respect to a rotation center of the rotatable developing member in a radial direction of the rotatable developing member. In the rotation direction of the rotatable developing member, the suction port is located upstream of a point on the outer peripheral surface of the rotatable developing member at which an absolute value of a magnetic flux density of the developing pole in a normal direction with respect to the outer peripheral surface of the rotatable developing member becomes a maximum value and downstream of a point on the outer peripheral surface of the rotatable developing member at which an absolute value of a magnetic flux density of the regulating pole in the normal direction with respect to the outer peripheral surface of the rotatable developing member becomes a maximum value. P1 is located downstream of P2 and upstream of P3 in the rotation direction of the rotatable developing member. P1 is a point at which a line connecting the rotation center of the rotatable developing member and a distal end of the first duct wall on a suction port side intersects the outer peripheral surface of the rotatable developing member. P2 being a point on the outer peripheral surface of the rotatable developing member at which an absolute value of a magnetic flux density of the first feeding pole in the normal direction with respect to the outer peripheral surface of the rotatable developing member becomes a maximum value. P3 being a point on the outer peripheral surface of the rotatable developing member at which an absolute value of a magnetic flux density of the second feeding pole in the normal direction with respect to the outer peripheral surface of the rotatable developing member becomes a maximum value. (Bc+B2)/2≥B1>Bc is satisfied. Bc is the maximum value of the absolute value of the magnetic flux density of the regulating pole in the normal direction with respect to the outer peripheral surface of the rotatable developing member. B1 is the maximum value of the absolute value of the magnetic flux density of the first feeding pole in the normal direction with respect to the outer peripheral surface of the rotatable developing member. B2 is the maximum value of the absolute value of the magnetic flux density of the second feeding pole in the normal direction with respect to the outer peripheral surface of the rotatable developing member. A circumferential length of the rotatable developing member in a range from P4 to P3 in the rotation direction of the rotatable developing member is ¼ or more of a circumferential length of the rotatable developing member in the range from P1 to P3 in the rotation direction of the rotatable developing member. P4 is a point on a side closer to P1 among points on the outer peripheral surface of the rotatable developing member at which the absolute value of the magnetic flux density of the second feeding pole in the normal direction with respect to the outer peripheral surface of the rotatable developing member becomes a half value of the maximum value.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to a first embodiment.

FIG. 2 is a schematic cross-sectional view illustrating a configuration of a developing unit according to the first embodiment.

FIG. 3 is a view illustrating arrangement of magnetic poles of a developing roller according to the first embodiment.

FIG. 4 is an enlarged cross-sectional view of the periphery of the developing roller and the duct according to the first embodiment.

FIG. 5A is a schematic diagram illustrating a relationship of a force acting on a carrier in a region TH located downstream of P1 in a rotation direction of a developing sleeve, and is a diagram illustrating a case where a direction of a magnetic force Fθ acting on the carrier is the same as a direction of suction into a duct.

FIG. 5B is a schematic diagram illustrating a relationship of a force acting on a carrier in a region TH located downstream of P1 in a rotation direction of a developing sleeve, and is a diagram illustrating a case where a direction of a magnetic force Fθ acting on the carrier is opposite to a direction of suction into a duct.

FIG. 6 is a graph illustrating a distribution of magnetic characteristics acting on a carrier on a developing sleeve according to Comparative Example 1.

FIG. 7 is a graph illustrating a distribution of magnetic characteristics acting on a carrier on a developing sleeve according to Comparative Example 2.

FIG. 8 is a graph illustrating a distribution of magnetic characteristics acting on a carrier on a developing sleeve according to Comparative Example 3.

FIG. 9 is an enlarged cross-sectional view of a periphery of a developing roller and a duct according to Comparative Example 4.

FIG. 10 is a graph illustrating a distribution of magnetic characteristics acting on a carrier on a developing sleeve according to the first embodiment.

FIG. 11 is a graph illustrating a distribution of magnetic characteristics acting on a carrier on a developing sleeve according to another example of the first embodiment.

FIG. 12 is a graph illustrating a distribution of magnetic characteristics acting on a carrier on a developing sleeve according to a second embodiment.

FIG. 13 is a graph illustrating a distribution of magnetic characteristics acting on a carrier on a developing sleeve according to Comparative Example 5.

### DESCRIPTION OF THE EMBODIMENTS

### First Embodiment

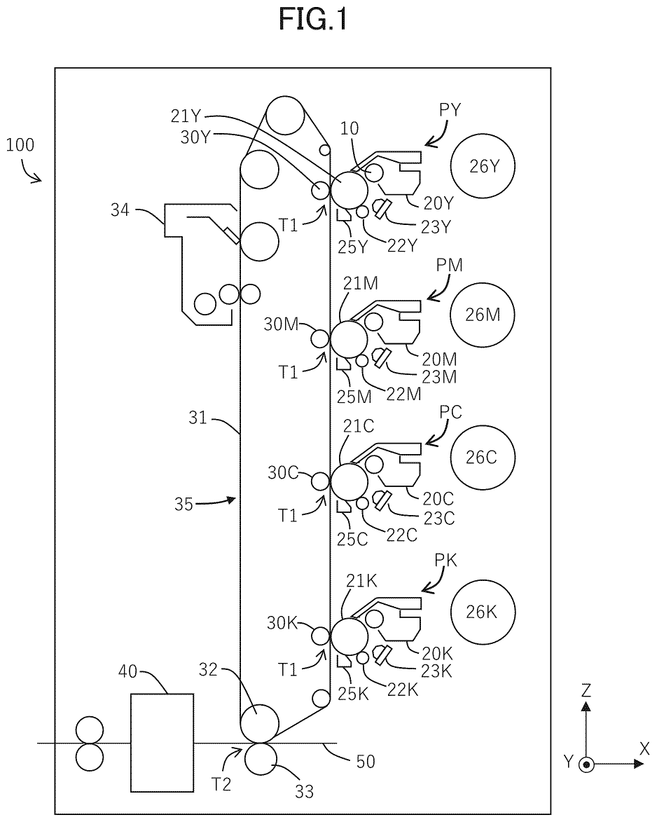

A first embodiment will be described with reference to FIGS. 1 to 11. First, a schematic configuration of an image forming apparatus according to the present embodiment will be described with reference to FIG. 1. Here, an X direction, a Y direction, and a Z direction perpendicular to each other are defined. In the present embodiment, the X direction and the Y direction are directions parallel to the horizontal plane, and the Z direction is a direction (vertical direction) perpendicular to the horizontal plane. The Y direction is a direction along a rotation axis direction of a developing sleeve 11 to be described below.

### Image Forming Apparatus

The image forming apparatus 100 is a full-color image forming apparatus, and, for example, is a multi-function peripheral (MFP) having a copying function, a printer function, and a scanning function in the present embodiment. As illustrated in FIG. 1, the image forming apparatus 100 includes image forming units PY, PM, PC, and PK that perform processes of forming toner images of four colors: yellow, magenta, cyan, and black, respectively, in parallel. In the image forming apparatus 100 according to the present embodiment, a host device such as a personal computer is communicably connected to a document reading device connected to a body of the image forming apparatus (apparatus body) or the apparatus body. Therefore, according to image information from the host device, a full-color image of four colors: yellow (Y), magenta (M), cyan (C), and black (K) can be formed on a recording material (recording paper, plastic sheet, cloth, etc.) using an electrophotographic system.

The image forming units PY, PM, PC, and PK for the respective colors include primary chargers 22Y, 22M, 22C, and 22K, developing units 20Y, 20M, 20C, and 20K, exposing units 23Y, 23M, 23C, and 23K, photosensitive drums 21Y, 21M, 21C, and 21K, and cleaning units 25Y, 25M, 25C, and 25K. In addition, the image forming apparatus 100 includes a transfer unit 35 and a fixing unit 40. Since the image forming units PY, PM, PC, and PK for the respective colors have similar configurations, the image forming unit PY will be described below as a representative.

The photosensitive drum 21Y serving as an image bearing member is a photosensitive member having a photosensitive layer made of a resin such as polycarbonate containing an organic photoconductor (OPC), and is configured to rotate at a predetermined speed. In the present embodiment, the linear velocity of the surface of the photosensitive drum 21Y is set to 650 mm/s. The primary charger 22Y includes a corona discharge electrode disposed around the photosensitive drum 21Y, and charges the surface of the photosensitive drum 21Y with generated ions.

The exposing unit (optical writing unit) 23Y incorporates a scanning optical device, and exposes the photosensitive drum 21Y charged on the basis of image data to lower the potential of the exposed portion, thereby forming a charge pattern (electrostatic latent image) corresponding to the image data. The developing unit 20Y transfers the developer accommodated therein to the photosensitive drum 21Y to develop the electrostatic latent image formed on the photosensitive drum 21Y. The developer is made by mixing a carrier and a toner corresponding to each color, and the electrostatic latent image is visualized by the toner.

The transfer unit 35 includes primary transfer rollers 30Y, 30M, 30C, and 30K, an intermediate transfer belt 31, and a secondary transfer outer roller 33. The intermediate transfer belt 31 is wound around the primary transfer rollers 30Y, 30M, 30C, and 30K, a secondary transfer inner roller 32, and a plurality of rollers, and is supported so as to be able to travel. The primary transfer rollers 30Y, 30M, 30C, and 30K serving as primary transfer members correspond to the respective colors: yellow (Y), magenta (M), cyan (C), and black (K) in this order from the top in FIG. 1. The secondary transfer outer roller 33 is disposed outside the intermediate transfer belt 31, and is configured to allow the recording material to pass between the secondary transfer outer roller 33 and the intermediate transfer belt 31 stretched around the secondary transfer inner roller 32.

The toner images of the respective colors formed on the photosensitive drums 21Y, 21M, 21C, and 21K are sequentially transferred (primary transferred) onto the intermediate transfer belt 31 by the action of a primary transfer bias applied to the primary transfer rollers 30Y, 30M, 30C, and 30K in primary transfer portions (primary transfer nips) T1 where the intermediate transfer belt 31 and the photosensitive drums 21Y, 21M, 21C, and 21K abut on each other. For example, for a full color image of four colors, toner images are transferred onto the intermediate transfer belt 31 in order from the photosensitive drum 21Y, and a color toner image in which yellow, magenta, cyan, and black layers are superimposed is formed.

On the other hand, a recording material 50 accommodated in a recording material accommodation portion (e.g., a cassette) (not illustrated) is fed toward the transfer unit 35 via a feeding roller (not illustrated). The recording material 50 is fed to a secondary transfer portion (nip portion) T2, where the intermediate transfer belt 31 stretched by the secondary transfer inner roller 32 and the secondary transfer outer roller 33 serving as a secondary transfer member abut on each other, in synchronization with the toner image on the intermediate transfer belt 31. Then, the toner image formed on the intermediate transfer belt 31 is secondarily transferred onto the recording material 50 by the action of a secondary transfer bias applied to the secondary transfer outer roller 33 in the secondary transfer portion T2. The recording material onto which the toner image has been transferred is subjected to pressure and heat in the fixing unit 40. As a result, the toners on the recording material are melted, and the color image is fixed to the recording material. Thereafter, the recording material 50 is discharged to the outside of the apparatus.

Residual toner and the like on the photosensitive drums 21Y, 21M, 21C, and 21K after the primary transfer process are collected by the cleaning units 25Y, 25M, 25C, and 25K. As a result, the photosensitive drums 21Y, 21M, 21C, and 21K are prepared for a next image forming process. In addition, residual toner and the like on the intermediate transfer belt 31 after the secondary transfer process are removed by an intermediate transfer belt cleaner 34.

Note that the image forming apparatus 100 according to the present embodiment can also form a monochrome or multicolor image using an image forming unit for a desired single color or image forming units for some of the four colors, such as a black monochrome image.

Developer storages 26Y, 26M, 26C, and 26K are provided to correspond to the developing units 20Y, 20M, 20C, and 20K, respectively, and are filled with bottles containing developers corresponding to the respective colors: yellow, magenta, cyan, and black in this order from the top in a replaceable manner. The developer storages 26Y, 26M, 26C, and 26K are configured to feed (supply) the developers to the developing units 20Y, 20M, 20C, and 20K corresponding to the colors of the developers stored therein.

For example, the toner weight ratios of the developers contained in the bottles are 80 to 95%, and the toner weight ratios of the developers in the developing units 20Y, 20M, 20C, and 20K are 5 to 10%. Therefore, when the toners are consumed by the development in the developing units 20Y, 20M, 20C, and 20K, the developers containing the toners corresponding to the consumption amounts are supplied, and the toner weight ratios of the developers in the developing units 20Y, 20M, 20C, and 20K are kept constant.

### Developing Unit

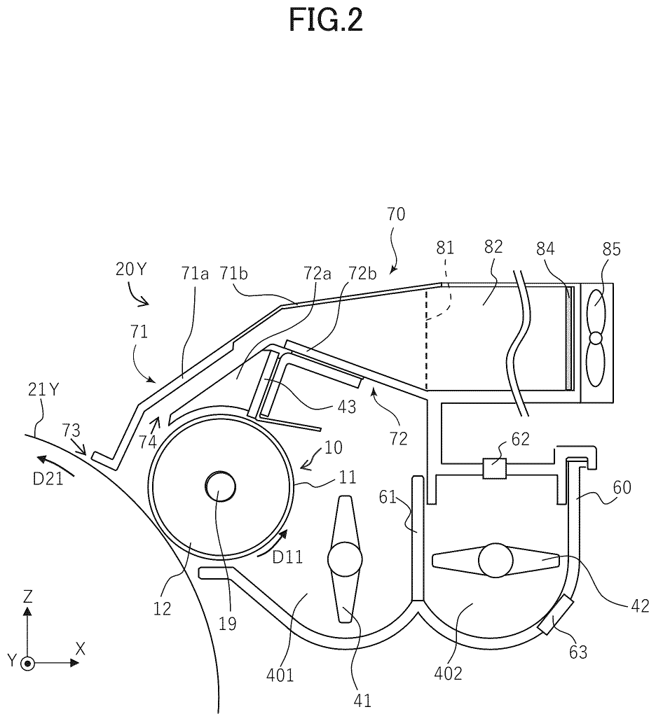

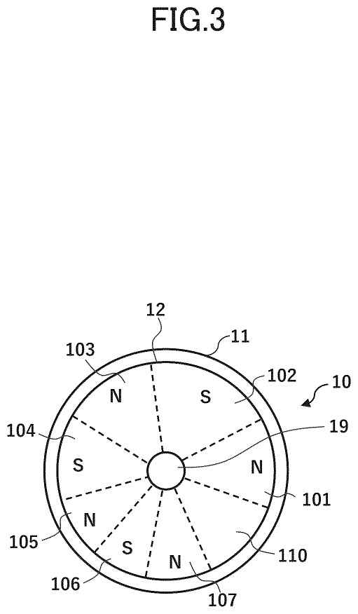

Next, the developing units 20Y, 20M, 20C, and 20K will be described in detail with reference to FIGS. 2 and 3. Since the developing units 20Y, 20M, 20C, and 20K have the same configuration, the developing unit 20Y will be described below. FIG. 2 is a conceptual diagram illustrating the developing unit 20Y illustrated in FIG. 1, and FIG. 3 is a conceptual diagram illustrating a magnetic pole configuration of a developing magnet 12 disposed in the developing unit 20Y.

As illustrated in FIG. 2, the developing unit 20Y includes a developing roller 10, a first screw 41, and a second screw 42, and these members are accommodated in a developer container 60. The developer container 60 accommodates a two-component developer including nonmagnetic toner and magnetic carrier. Specifically, the developer container 60 includes a first feeding chamber 401 and a second feeding chamber 402, and the developer is accommodated in the first feeding chamber 401 and the second feeding chamber 402. The first screw 41 is disposed in the first feeding chamber 401, and the second screw 42 is disposed in the second feeding chamber 402.

The developing roller 10 is a developer bearing member that is driven to rotate, and is disposed at a position adjacent to the photosensitive drum 21Y such that the rotation axis thereof is substantially parallel to the rotation axis of the photosensitive drum 21Y. The developing roller 10 includes a rotating developing sleeve 11 and a developing magnet (fixed magnet) 12 disposed inside the developing sleeve 11 in a non-rotating manner to attract the developer onto the surface of the developing sleeve 11 by a magnetic force. Then, the developing roller 10 attracts (carries) the developer drawn up from the first screw 41 based on the magnetic force, and develops the electrostatic latent image formed on the rotating photosensitive drum 21Y (on the image bearing member) with the developer.

Specifically, for example, a DC developing bias having the same polarity as the charging polarity of the primary charger 22Y or a developing bias in which a DC voltage having the same polarity as the charging polarity of the primary charger 22Y is superimposed on an AC voltage is applied to the developing sleeve 11 of the developing unit 20Y. As a result, reversal development is performed in which a toner charged to the same polarity as the charging polarity of the primary charger 22Y adheres to the electrostatic latent image formed on the photosensitive drum 21Y by the exposing unit 23Y.

The developing sleeve 11 is a nonmagnetic cylindrical member, and is driven to rotate around a rotation shaft 19. The rotation direction of the developing sleeve 11 is a counterclockwise direction as indicated by an arrow D11 in FIG. 2, and is the same as the rotation direction of the photosensitive drum 21Y (a direction indicated by an arrow D21) in the present embodiment. Therefore, the developing sleeve 11 rotates so that the surface moves in a direction opposite to the surface of the photosensitive drum 21Y at a position (facing portion) facing the photosensitive drum 21Y.

The developing magnet 12 is disposed inside the developing sleeve 11, and includes a plurality of sectored magnetic poles 101 to 107 and a sectored low magnetic force portion 110 as illustrated in FIG. 3. A space that allows the developing sleeve 11 to rotate is disposed between the inner periphery of the developing sleeve 11 and the outer periphery of the developing magnet 12. In the present embodiment, the developing magnet 12 has a total of seven magnetic poles. The magnetic poles 101, 102, 103, 104, 105, 106, and 107 are arranged so as to be adjacent to one another in the rotation direction of the developing sleeve 11, and are an N pole, an S pole, an N pole, an S pole, an N pole, an S pole, and an N pole, respectively. As the developing sleeve 11 rotates, each magnetic pole feeds the developer attracted by the magnetic pole 101 as will be described below.

In addition, in the present embodiment, the low magnetic force portion 110 having a magnetic force lower than that of the magnetic pole 107 is formed by a repulsive magnetic field generated in cooperation between the magnetic pole 107 and the magnetic pole 101, which is disposed downstream of the magnetic pole 107 in the rotation direction of the developing sleeve 11 and has the same polarity as the magnetic pole 107. The developer is peeled off from the developing sleeve 11 by the low magnetic force portion 110. Note that the low magnetic force portion 110 has almost no magnetic force in the present embodiment, but may have a low magnetic force, and for example, the magnetic force (the absolute value of the normal component Br of the magnetic flux density) may be 10 mT or less, or even 5 mT or less.

The magnetic pole 101 is a magnetic pole that draws up the developer from the first feeding chamber 401, and may hereinafter be referred to as the drawing-up pole 101. The magnetic pole 102 serving as a first magnetic pole is a magnetic pole disposed at a position where the developing sleeve 11 is closest to a regulating blade 43 serving as a layer thickness regulating member to be described below, and may hereinafter be referred to as the cut pole 102. The magnetic pole 103 serving as a second magnetic pole is a magnetic pole disposed downstream of the cut pole 102 in the rotation direction of the developing sleeve 11, and may hereinafter be referred to as the first feeding pole 103. The magnetic pole 104 serving as a third magnetic pole is a magnetic pole disposed adjacent to the first feeding pole 103 downstream of the first feeding pole 103 in the rotation direction of the developing sleeve 11 and having different polarity from the first feeding pole 103, and may hereinafter be referred to as the second feeding pole 104. The magnetic pole 105 serving as a fourth magnetic pole is a magnetic pole disposed downstream of the second feeding pole 104 in the rotation direction of the developing sleeve 11 and disposed at a position where the developing sleeve 11 is closest to the photosensitive drum 21Y, and may hereinafter be referred to as the developing pole 105. The magnetic pole 106 is a magnetic pole disposed downstream of the developing pole 105 in the rotation direction of the developing sleeve 11, and may hereinafter be referred to as the third feeding pole 106. The magnetic pole 107 is a magnetic pole disposed downstream of the third feeding pole 106 in the rotation direction of the developing sleeve 11 and having the same polarity as the drawing-up pole 101 disposed further downstream with the low magnetic force portion 110 interposed therebetween, and may hereinafter be referred to as the peeling pole 107.

The developer is flipped up as the first screw 41 feeds the developer, and is supplied onto the developing sleeve 11. Since the developer contains a magnetic carrier, the developer is restrained by the drawing-up pole 101 of the developing magnet 12. Next, due to the rotational operation of the developing sleeve 11, the amount (layer thickness) of the developer carried on the developing sleeve 11 is regulated to a predetermined amount by the regulating blade 43 when the developer passes through the cut pole 102. The developer whose layer thickness has been regulated passes through the first feeding pole 103 and the second feeding pole 104, is fed to the developing pole 105 facing the photosensitive drum 21Y, and develops the latent image formed on the photosensitive drum 21Y. After the latent image formed on the photosensitive drum 21Y is developed, the developer on the developing sleeve 11 is fed by a rotating operation of the developing sleeve 11, passes through the third feeding pole 106 toward the downstream side in the rotation direction, is released from the magnetic restraint force between the drawing-up pole 101 and the peeling pole 107 having the same polarity, and is collected in the first feeding chamber 401.

The first screw 41 and the second screw 42 are screw feeding members that feed the developer in one direction while stirring the developer, and are arranged such that rotation axes thereof are substantially parallel to each other. The rotation axis of each of the screws is also substantially parallel to the rotation axis of the developing roller 10.

As illustrated in FIG. 2, the first screw 41 is positioned between the developing roller 10 and the second screw 42, and a partition wall 61 of the developer container 60 is disposed between the first screw 41 and the second screw 42. The partition wall 61 of the developer container 60 extends along the rotation axis direction of the first screw 41 and the second screw 42. The partition wall 61 has a communication port (not illustrated) serving as a communication portion that allows communication between the first feeding chamber 401, in which the developer is fed by the first screw 41, and the second feeding chamber 402, in which the developer is fed by the second screw 42. The communication port is an opening portion formed in the partition wall 61.

The developer feeding directions of the first screw 41 and the second screw 42 are opposite to each other. The starting end side (the upstream end side in the developer feeding direction) and the terminating end side (the downstream end side in the developer feeding direction) of the first feeding chamber 401, in which the first screw 41 is disposed, communicate with the terminating end side and the starting end side of the second feeding chamber 402, in which the second screw 42 is disposed, via a communication port formed in the partition wall 61. Therefore, the developer circulates in the rotation direction of the first screw 41 and the second screw 42 and in the Y direction in the developer container 60, and a part of the developer is supplied toward the developing roller 10.

A developer supply port 62 (see FIG. 2) is disposed above the second screw 42 in the developer container 60, and is connected to the developer storage 26Y (see FIG. 1). The developer supply port 62 is configured to supply the developer contained in the bottle filled in the developer storage 26Y to the second feeding chamber 402 in which the second screw 42 is disposed. As described above, since the toner weight ratio of the developer contained in the bottle of the developer storage 26Y is larger than the toner weight ratio of the developer in the developing unit 20Y, the toner weight ratio of the developer in the developing unit 20Y can be kept constant by adjusting the developer to be supplied to the second screw 42.

A toner density detection sensor 63 (see FIG. 2) is disposed to detect a toner density in the developer in the developer container 60. In the present embodiment, the toner density detection sensor 63 is disposed in the second feeding chamber 402. The toner density detection sensor 63 is a sensor that detects a magnetic permeability of the developer. The toner density corresponds to the consumption amount of toner in the developing unit 20Y, and is therefore used to control the supply of the developer from the developer storage 26Y. For example, when it is detected that the toner density is lower than a predetermined value, the developer is supplied from the developer storage 26Y. Since the magnetic permeability of the developer changes depending on the toner density, the toner density can be detected using the magnetic permeability.

The regulating blade 43 serving as a layer thickness regulating member is disposed adjacent to the developing roller 10, and is used to regulate the amount of developer supplied from the first feeding chamber 401 to the developing roller 10. The regulating blade 43 is disposed such that a distal end thereof faces the surface of the developing sleeve 11 with a gap therebetween, and regulates the amount (layer thickness) of the developer carried on the surface of the developing sleeve 11 based on the gap.

As described above, in the present embodiment, the two-component development method is used as a development method, and a mixture of a nonmagnetic toner having a negative charging polarity and a magnetic carrier is used as the developer. The nonmagnetic toner is negatively charged by friction with the magnetic carrier, and the magnetic carrier is positively charged. The nonmagnetic toner is obtained by incorporating a colorant, a wax component, or the like in a resin such as polyester or styrene acryl, which are then pulverized or polymerized to form powder, and then adding a fine powder of titanium oxide, silica, or the like to the surface. The magnetic carrier is obtained by applying resin coating to a surface layer of a core made of ferrite particles or resin particles obtained by kneading magnetic powder. The toner density in the developer in the initial state (the weight ratio of the toner contained in the developer) is 8% in the present embodiment.

In general, a two-component development method using a toner and a carrier has a feature that the toner is subjected to less stress than a one-component development method using a one-component developer, because both the toner and the carrier are charged to a predetermined polarity by bringing the toner and the carrier into frictional contact with each other. On the other hand, the long-term use increases the amount of soiling (spent) adhering to the carrier surface, which gradually reduces the ability to charge the toner. As a result, problems of fogging and toner scattering occur. In order to prolong the life of the two-component developing unit, it is conceivable to increase the amount of carrier contained in the developing unit, but this is not desirable because it leads to an increase in size of the developing unit.

In order to solve the above-described problems associated with the two-component developer, the present embodiment adopts an auto carrier refresh (ACR) method. The ACR method is a method of suppressing an increase of deteriorated carrier by supplying a new developer from the developer storage 26Y into the developing unit 20Y little by little and discharging a developer having deteriorated charging performance little by little from a discharge port (not illustrated) of the developing unit 20Y. As a result, the deteriorated carrier in the developing unit 20Y is replaced with a new carrier little by little, and the charging performance of the carrier in the developing unit 20Y can be kept substantially constant.

### Duct

In the developing unit 20Y, the toner is likely to scatter as the developer is fed by the rotating developing sleeve 11. When toner scattering occurs, the scattered toner may accumulate in the vicinity of the developing unit 20Y and the photosensitive drum 21Y, and the accumulated toner may fall onto the developing sleeve 11 or the photosensitive drum 21Y due to vibration during image formation or maintenance. Therefore, the developing unit 20Y according to the present embodiment includes a duct 70 that sucks the scattered toner in order to collect the scattered toner and discharge the collected toner to the outside of the apparatus. That is, the developing unit 20Y includes the duct 70 that sucks the developer around the developing sleeve.

As illustrated in FIG. 2, the duct (suction duct) 70 is disposed above the developer container 60. The duct 70 has a suction port 74 located upstream of the position where the developing sleeve 11 is closest to the photosensitive drum 21Y and downstream of the regulating blade 43 in the rotation direction of the developing sleeve 11 to suck the developer, and extends from the suction port 74 to the upstream side in the rotation direction of the developing sleeve 11. The duct 70 has a duct lower portion 72 serving as a first duct wall and a duct upper portion 71 serving as a second duct wall. The duct lower portion 72 is disposed so as to face a part of the developing roller 10 with a gap therebetween. The duct upper portion 71 is disposed to face the duct lower portion 72, and forms a space between the duct upper portion 71 and the duct lower portion 72 through which the developer sucked from the suction port 74 flows.

The duct lower portion 72 is fixed to the developer container 60 so as to cover the first feeding chamber 401, the developing roller 10, and the regulating blade 43 from above. The duct lower portion 72 has a shape in which two flat plates extending in the Y direction are joined together. The duct lower portion 72 includes a first lower portion 72a having an inclined surface inclined upward from an end portion on the negative side in the X direction (the photosensitive drum 21Y side) toward the positive side in the X direction (the side separated from the photosensitive drum 21Y), and a second lower portion 72b extending from a portion in contact with the first lower portion 72a toward the positive side in the X direction.

The duct upper portion 71 is disposed above the duct lower portion 72 so as to cover the entire duct lower portion 72 from above. The duct upper portion 71 has a shape in which two flat plates extending in the Y direction are joined together. The duct upper portion 71 includes a first upper portion 71a having an inclined surface inclined upward from an end portion on the negative side in the X direction toward the positive side in the X direction, and a second upper portion 71b extending from a portion in contact with the first upper portion 71a toward the positive side in the X direction.

The first lower portion 72a of the duct lower portion 72 and the first upper portion 71a of the duct upper portion 71 are arranged such that the upper surface of the first lower portion 72a and the lower surface of the first upper portion 71a face each other. The second lower portion 72b of the duct lower portion 72 and the second upper portion 71b of the duct upper portion 71 are also arranged such that the upper surface of the second lower portion 72b of the duct lower portion 72 and the lower surface of the second upper portion 71b of the duct upper portion 71 face each other. However, the second lower portion 72b and the second upper portion 71b are arranged so as to become more separated from each other toward the positive side in the X direction.

The duct upper portion 71 is fixed to the developer container 60 such that an end portion on the negative side in the X direction is located to be separated from the photosensitive drum 21Y by a predetermined distance. The end portion of the duct upper portion 71 on the negative side in the X direction faces the photosensitive drum 21Y downstream of the position where the photosensitive drum 21Y faces the developing roller 10 in the rotation direction of the photosensitive drum 21Y.

The end portion of the duct lower portion 72 on the negative side in the X direction is located between a position where the developing roller 10 faces the regulating blade 43 and a position where the developing roller 10 faces the photosensitive drum 21Y in the rotation direction of the developing roller 10. The suction port 74 of the duct 70 is located between the end portion of the duct lower portion 72 on the negative side in the X direction and the duct upper portion 71.

The duct 70 has a discharge port 81 that is open to an exhaust duct 82 at an end portion on the positive side in the X direction and at an end portion in the Y direction. The discharge port 81 allows a space surrounded by the duct upper portion 71 and the duct lower portion 72 to communicate with the internal space of the exhaust duct 82. The exhaust duct 82 has a tubular shape, and an end portion opposite to an end portion connected to the discharge port 81 of the exhaust duct 82 is open to the outside via a dust collection filter 84 and a fan 85.

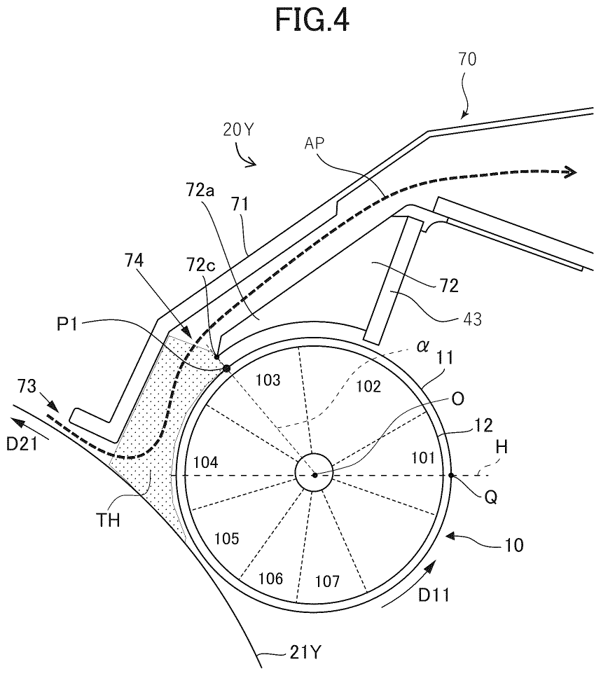

In the duct 70, a flow path AP (see FIG. 4) for air sucked from a gap 73 between the photosensitive drum 21Y and the duct upper portion 71 is generated when the fan 85 serving as an airflow generator rotates. The air sucked from the gap 73 passes through a region TH surrounded by the developing sleeve 11, the photosensitive drum 21Y, and the duct upper portion 71, passes through the suction port 74 constituted by the duct upper portion 71 and the duct lower portion 72, and flows to the exhaust duct 82. The toner scattered in the region TH (hereinafter, referred to as “scattered toner”) is fed to the exhaust duct 82 through the flow path AP.

This scattered toner is generated by the following mechanism. If the developer deteriorates when left or used in a high-temperature and high-humidity environment, the charge amount of the toner decreases, and the electrostatic adhesion force of the toner with the carrier decreases. Then, the force that tries to separate the toner from the carrier due to the centrifugal force caused when the developing sleeve 11 rotates or the impact caused as the developer moves between the magnetic poles becomes larger than the electrostatic adhesion force between the carrier and the toner, and the toner may be separated from the carrier and scattered toner may be generated.

As a method of preventing the scattered toner from leaking to the outside of the developing unit, it may be considered to seal a gap between the photosensitive drum and the developing unit with a urethane sheet or the like. However, as described above, if the sealing method using the contact with the photosensitive drum 21Y is adopted to suppress the leakage of the scattered toner in the region TH after the toner is developed on the photosensitive drum 21Y, the toner image formed on the photosensitive drum 21Y is disturbed. Therefore, it is difficult to adopt this method. Therefore, in the present embodiment, as described above, the scattered toner is sucked by the duct 70.

Suppression of Separation of Carrier from Developing Sleeve

Meanwhile, when scattered toner is sucked by the duct 70, since the developer on the surface of the developing sleeve 11 is exposed to the flow path AP for air, carrier may also be sucked unintendedly together with the toner. This is because of the following mechanism.

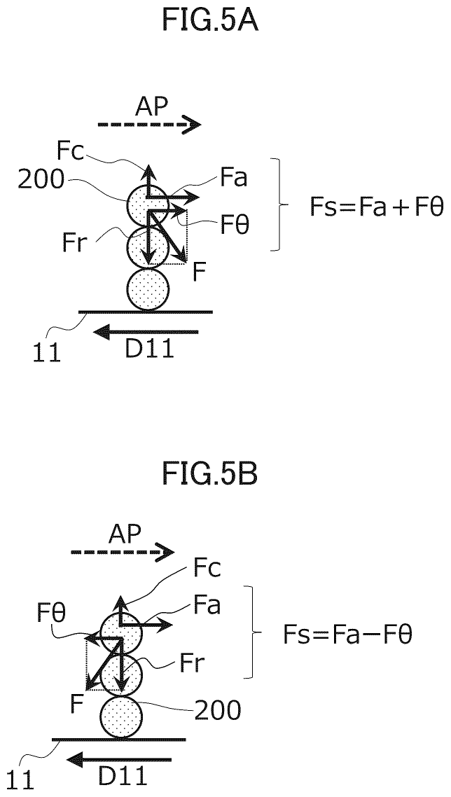

As illustrated in FIG. 4, P1 denotes a point at which a line α intersects the surface of the developing sleeve 11, the line α connecting a distal end 72c of the duct lower portion 72 on the suction port 74 side (suction port side) and the rotation center O of the developing sleeve 11. FIGS. 5A and 5B are schematic diagrams each illustrating a force acting on the carrier on the developing sleeve 11 in the region TH located downstream of P1 in the rotation direction of the developing sleeve 11.

A magnetic force F acts on a carrier 200 on the developing sleeve 11 due to the interaction between the magnetic poles arranged in the developing magnet 12. The magnetic force F is divided into a magnetic force Fr in the normal direction of the developing sleeve 11 and a magnetic force Fθ in the tangential direction (rotation direction D11) of the developing sleeve 11. In the normal direction of the developing sleeve 11, the magnetic force Fr and a centrifugal force Fc caused by the rotation of the developing sleeve 11 act on the carrier 200. At this time, the maximum static frictional force Fm in the rotation direction of the developing sleeve 11 is Fm=μ(Fr−Fc), μ being a static friction coefficient between the carriers 200 or between the carrier 200 and the developing sleeve 11.

On the other hand, a force Fs acting on the carrier 200 in the rotation direction of the developing sleeve 11 is a resultant force of a wind load Fa acting due to the wind pressure and the magnetic force Fθ because the carrier 200 on the developing sleeve 11 in the region TH is exposed to the flow path AP for air to the duct 70. Here, when the force Fs>the maximum static frictional force Fm, the carrier 200 may be separated from the developing sleeve 11, and the separated carrier may be fed toward the exhaust duct 82 along the flow path AP together with the scattered toner.

That is, as illustrated in FIG. 5A, when the direction of the magnetic force Fθ is the same as the direction (the suction direction or the direction of the wind load Fa) in which air flows in the flow path AP (the direction opposite to the rotation direction of the developing sleeve 11), the force Fs=the wind load Fa+the magnetic force Fθ. Therefore, the force Fs is likely to be larger than the maximum static frictional force Fm, and the carrier is likely to be separated from the developing sleeve 11.

Therefore, in the present embodiment, as illustrated in FIG. 5B, in the region where the developer on the developing sleeve 11 is exposed to the flow path AP for air, the magnetic flux densities of the plurality of magnetic poles stationarily arranged in the developing magnet 12 are set such that the direction of the magnetic force Fθ is opposite to the direction of the wind load Fa (is the same as the rotation direction of the developing sleeve 11). Then, the force Fs is equal to the wind load Fa−the magnetic force Fθ and the force Fs is smaller than the maximum static frictional force Fm, thereby making it difficult for the carrier to be separated from the developing sleeve 11.

Here, the direction of the magnetic force Fθ acting on the carrier on the developing sleeve 11 will be described. The magnetic force Fθ changes depending on the position of the carrier on the developing sleeve 11 and the configuration of the magnetic flux density distribution between the magnetic poles stationarily arranged in the developing magnet 12. That is, when the carrier 200 exists between the first feeding pole 103 and the second feeding pole 104, the direction of the magnetic force Fθ can be either the same as or opposite to the rotation direction of the developing sleeve 11 depending on the influence of the magnetic flux densities of the first feeding pole 103 and the second feeding pole 104 at the position where the carrier 200 exists.

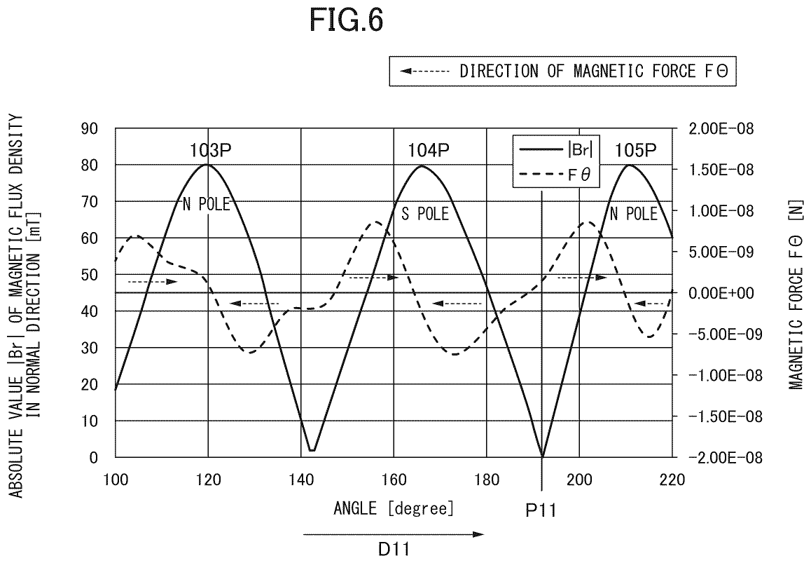

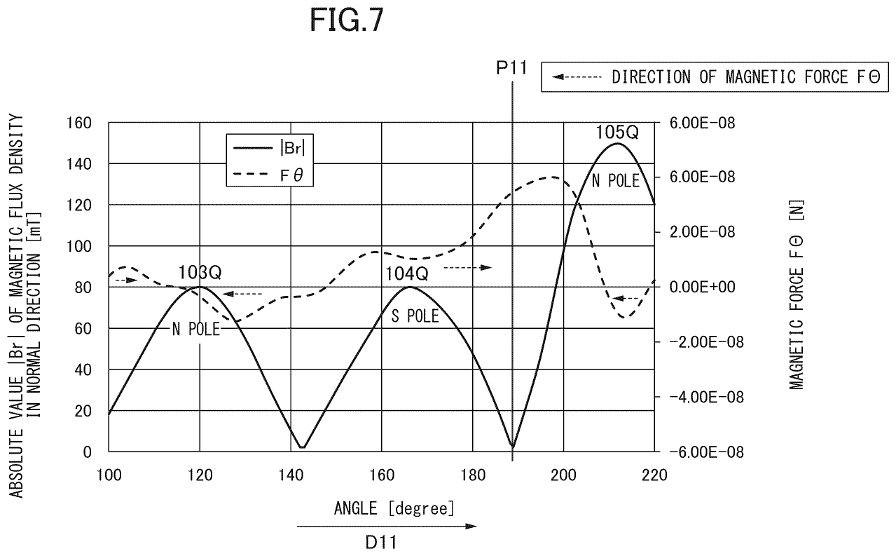

The relationship between the magnetic flux density and the magnetic force Fθ will be described with reference to FIGS. 6 and 7 illustrated as Comparative Examples 1 and 2. The graph of FIG. 6 shows a distribution of magnetic characteristics acting on the carrier on the developing sleeve 11 in the configuration according to Comparative Example 1. In the configuration according to Comparative Example 1, a developing magnet having a plurality of magnetic poles including three magnetic poles 103P, 104P, and 105P, whose absolute values |Br| of magnetic flux densities in the normal direction are substantially the same, is disposed inside the developing sleeve 11 having a diameter of 25 mm. The magnetic poles 103P, 104P, and 105P correspond to the first feeding pole 103, the second feeding pole 104, and the developing pole 105 illustrated in FIG. 3, respectively. The magnetic poles 103P, 104P, and 105P are disposed such that adjacent magnetic poles have different polarities.

In the graph of FIG. 6, the angle on the developing sleeve 11 is plotted on the horizontal axis, and the absolute value |Br| of the magnetic flux density and the magnetic force Fθ are plotted on the vertical axis. The angle is defined as 0 degrees at point Q (FIG. 4) on the side opposite to the photosensitive drum 21Y (the side in the positive direction of the X axis from the rotation center O of the developing sleeve 11) among points where a horizontal line H (FIG. 4) passing through the rotation center O of the developing sleeve 11 intersects the surface of the developing sleeve 11, and the rotation direction D11 of the developing sleeve 11 is defined as positive. In the graph, the absolute value |Br| of the magnetic flux density is indicated by a solid line, and the magnetic force Fθ acting on a carrier having a diameter of 35 μm and a relative magnetic permeability of 5 at a position of 100 μm from the surface of the developing sleeve 11 (on a circumference having a diameter of 25.2 mm) is indicated by a broken line. The graphs shown below are also derived under the same conditions. In addition, as a sign of the magnetic force Fθ, a plus indicates a force in the direction that is the same as the rotation direction D11 of the developing sleeve 11. Furthermore, a direction of an arrow indicated by a broken line on the graph indicates a direction of the magnetic force Fθ.

The magnetic flux density and the magnetic force (magnetic force) generated by the developing magnet will be described. In the description of the present embodiment, Br, Bθ, Fr, and Fθ are defined as follows.
Br: a magnetic flux density in the normal direction (perpendicular direction) with respect to the outer peripheral surface (surface) of the developing sleeve 11 at a certain point
Bθ: a magnetic flux density in the tangential direction with respect to the outer peripheral surface of the developing sleeve 11 at a certain point
Fr: a magnetic force acting in the normal direction with respect to the outer peripheral surface of the developing sleeve 11 at a certain point (however, the suction direction (the direction toward the developing sleeve 11) is defined as negative.)
Fθ: a magnetic force acting in the tangential direction with respect to the outer peripheral surface of the developing sleeve 11 at a certain point (however, the rotation direction of the developing sleeve 11 is defined as positive.)

Unless otherwise specified, Br, Bθ, Fr, and Fθ refer to a magnetic flux density or a magnetic force at a certain point on the developing sleeve 11.

### Method for Measuring Magnetic Force or Magnetic Flux Density

Next, a method for measuring a magnetic force in the present embodiment will be described. The magnetic force described in the present embodiment can be calculated by a calculation method to be described below. The magnetic force acting on the carrier is obtained by the following Formula (1). Here, μ₀ is a magnetic permeability of the vacuum, μ is a magnetic permeability of the carrier, b is a radius of the carrier, and B is a magnetic flux density.

$$\begin{matrix}[ Mathematical formula 1 ] & \\ \vec{F} = \frac{μ - {μ}_{0}}{\text{?} ( μ + 2 \text{?} )} 2 π {b}^{3} ∇ {B}^{2} & ( 1 )\end{matrix}$$

$$\text{?} \text{indicates text missing or illegible when filed}$$

### Thus,

$$\begin{matrix}[ Mathematical formula 2 ] & \\ & ( 2 )\end{matrix}$$

$$\vec{F} ∝ ∇ {B}^{2} = \frac{\partial }{\partial r} ( {Br}^{2} + B {θ}^{2} ) \text{?} + \frac{\text{?}}{r} \frac{\partial }{\partial θ ( \text{?} + \text{?} )} \text{?} ∴ {\underbrace{\vec{F} ∝ ( \text{?} \frac{\partial \text{?}}{\partial r} + \text{?} \frac{\partial \text{?}}{\partial r} ) \text{?}}}_{Fr} + {\underbrace{\frac{\text{?}}{r} ( \text{?} \frac{\partial \text{?}}{\partial θ} + \text{?} \frac{\partial \text{?}}{\partial θ} ) \text{?}}}_{F θ}$$

$$\text{?} \text{indicates text missing or illegible when filed}$$

If Br and Bθ are known from Formula (2), Fr and Fθ can be obtained. Here, the magnetic flux density Br is measured using a magnetic field measuring device “MS-9902” (product name) manufactured by F.W.BELL as a measuring device with a distance between a probe, which is a member of the measuring device, and a surface of a developing sleeve set to about 100 μm.

Further, Bθ can be obtained as follows. A vector potential A_{Z}(R,θ) at a position where the magnetic flux density Br is measured is calculated by Formula (3) using the measured magnetic flux density Br.

$$\begin{matrix}[ Mathematical formula 3 ] & \\ \text{?} ( \text{?} θ ) = \text{?} RBrd θ & ( 3 )\end{matrix}$$

$$\text{?} \text{indicates text missing or illegible when filed}$$

The boundary condition is defined as A_{Z}(R,θ), and the following equation is solved to obtain A_{Z}(r,θ).

∇²A_{Z}(R,θ)=0 Then, Br and Bθ can be obtained by Formulas (4) and (5).

$$\begin{matrix}[ Mathematical formula 4 ] & \\ \text{?} = \frac{\text{?}}{r} \frac{\partial \text{?} ( r , θ )}{\partial θ} & ( 4 )\end{matrix}$$

$$\begin{matrix}[ Mathematical formula 5 ] & \\ \text{?} = - \frac{\partial \text{?} ( r , θ )}{\partial r} & ( 5 )\end{matrix}$$

$$\text{?} \text{indicates text missing or illegible when filed}$$

Fr and Fθ can be derived by applying Br and Bθ measured and calculated as described above to Formula (1). According to the above formula, a magnetic flux density distribution forming the Fr distribution necessary in the present embodiment can be obtained.

In general, the magnetic force is directed toward the side where the magnetic flux density is larger. Thus, when the absolute values |Br| of the magnetic flux densities in the normal direction of the adjacent magnetic poles are substantially the same, the magnetic force Fθ in the vicinity of the magnetic pole acts toward the position of the maximum value of the magnetic flux density in the normal direction indicating the polarity of the magnetic pole. For example, a magnetic force Fθ in the direction of the magnetic pole 103P acts on the carrier in the vicinity of the magnetic pole 103P disposed at angle of about 120 degrees. That is, a magnetic force Fθ acts in a direction that is the same as the rotation direction of the developing sleeve 11 upstream of 120 degrees in the rotation direction D11, and a magnetic force Fθ acts in a direction opposite to the rotation direction of the developing sleeve 11 downstream of 120 degrees in the rotation direction D11. The magnetic force Fθ similarly acts in the vicinity of the magnetic pole 104P and in the vicinity of the magnetic pole 105P.

In addition, the direction of the magnetic force Fθ also changes in the vicinity of the point where the magnetic pole changes to a different pole. For example, a point P11 where the polarity changes from the magnetic pole 104P toward the magnetic pole 105P exists at an angle of about 190 degrees. A magnetic force Fθ in a direction toward the magnetic pole 104P acts on the carrier in the vicinity of the point P11 where the polarity changes upstream of the point P11 in the rotation direction D11, and a magnetic force Fθ in a direction toward the magnetic pole 105P acts on the carrier in the vicinity of the point P11 where the polarity changes downstream of the point P11 in the rotation direction D11. This is because the magnitudes of the magnetic influences of the magnetic pole 104P and the magnetic pole 105P are switched with the point P11 as a boundary.

On the other hand, the graph of FIG. 7 shows a distribution of magnetic characteristics acting on the carrier on the developing sleeve 11 in the configuration according to Comparative Example 2. In the graph, similarly to FIG. 6, the absolute value |Br| of the magnetic flux density is indicated by a solid line, and the magnetic force Fθ acting on the carrier is indicated by a broken line. In the configuration according to Comparative Example 2 as well, similarly to Comparative Example 1, a developing magnet having a plurality of magnetic poles including three magnetic poles 103Q, 104Q, and 105Q, whose absolute values |Br| of magnetic flux densities in the normal direction are substantially the same, is disposed inside the developing sleeve 11 having a diameter of 25 mm. The magnetic poles 103Q, 104Q, and 105Q correspond to the first feeding pole 103, the second feeding pole 104, and the developing pole 105 illustrated in FIG. 3, respectively. The magnetic poles 103Q, 104Q, and 105Q are disposed such that adjacent magnetic poles have different polarities.

The graph of FIG. 7 shows a case where the absolute value |Br| of the magnetic flux density in the normal direction of the magnetic pole 105Q is larger than that of the magnetic pole 104Q. As the absolute value |Br| of the magnetic flux density in the normal direction of the magnetic pole 105Q increases, the magnetic influence of the magnetic pole 105Q on the carrier in the vicinity of the magnetic pole 104Q becomes stronger. That is, when the absolute value |Br| of the magnetic flux density in the normal direction of the magnetic pole 105Q becomes larger than that of the magnetic pole 104Q, the carrier existing in the vicinity of the magnetic pole 104Q is attracted to the magnetic pole 105Q, and the magnetic force Fθ in the entire vicinity of the magnetic pole 104Q is always directed toward the magnetic pole 105Q (the rotation direction D11 of the developing sleeve 11). Naturally, the carrier in the vicinity of the point P11 is also directed toward the magnetic pole 105Q, with the direction of the magnetic force Fθ remaining unchanged. In this manner, the direction of the magnetic force Fθ changes depending on the magnitude relationship between the adjacent magnetic poles.

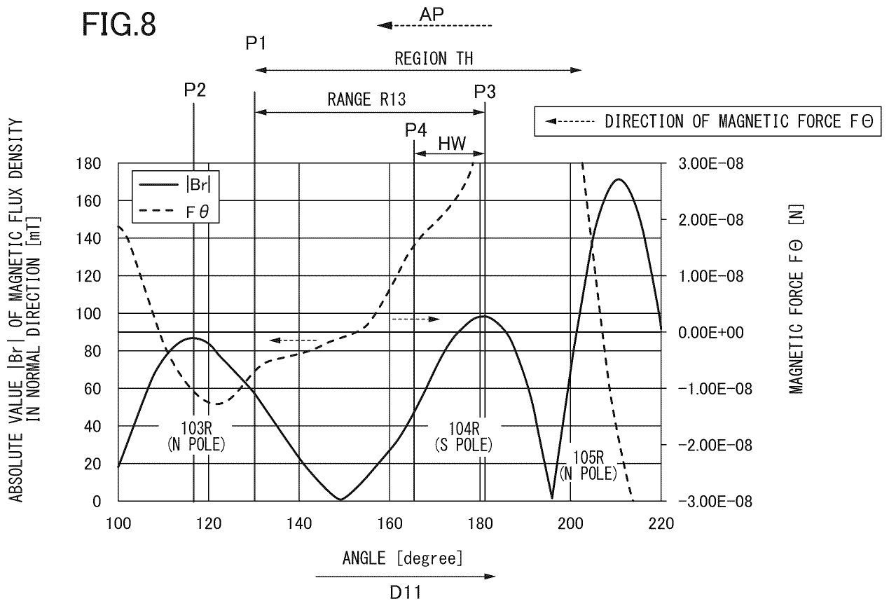

Next, the configuration according to Comparative Example 3 will be described using a graph illustrated in FIG. 8. The graph of FIG. 8 shows a distribution of magnetic characteristics acting on the carrier on the developing sleeve 11 in the configuration according to Comparative Example 3. In the graph, similarly to FIG. 6, the absolute value |Br| of the magnetic flux density is indicated by a solid line, and the magnetic force Fθ acting on the carrier is indicated by a broken line. In the configuration according to Comparative Example 3 as well, similarly to Comparative Example 1, a developing magnet having a plurality of magnetic poles including three magnetic poles 103R, 104R, and 105R, whose absolute values |Br| of magnetic flux densities in the normal direction are substantially the same, is disposed inside the developing sleeve 11 having a diameter of 25 mm. The magnetic poles 103R, 104R, and 105R correspond to the first feeding pole 103, the second feeding pole 104, and the developing pole 105 illustrated in FIG. 3, respectively. The magnetic poles 103R, 104R, and 105R are disposed such that adjacent magnetic poles have different polarities.

In the graph of FIG. 8, P1 denotes a point at which a line α intersects the surface of the developing sleeve 11, the line α connecting a distal end 72c of the duct lower portion 72 on the suction port 74 side and the rotation center O of the developing sleeve 11 as described above with reference to FIG. 4. Further, P2 denotes a position where the absolute value of the magnetic flux density in the normal direction of the magnetic pole 103R on the developing sleeve 11 is maximum, and P3 denotes a position where the absolute value of the magnetic flux density in the normal direction of the magnetic pole 104R on the developing sleeve 11 is maximum. In addition, the sign of the magnetic force Fθ is positive in a direction from P1 to P3 (a direction opposite to the direction in which air flows in the flow path AP). The subsequent diagrams for magnetic characteristic distributions have similar configurations.

The absolute value of the magnetic flux density of the magnetic pole 105R disposed at a position facing the photosensitive drum 21Y is usually larger than the absolute values of the magnetic flux densities of the surrounding magnetic poles. This is to increase the magnetic binding force of the carrier to the developing sleeve 11, and to suppress the image defect caused by the erroneous adhesion of the carrier to the photosensitive drum 21Y. In addition, by increasing the absolute value of the magnetic flux density of the magnetic pole 105R, the magnetic brush of the developer on the developing sleeve 11 is made dense, aiming to form a toner image with less unevenness on the photosensitive drum 21Y.

Therefore, in Comparative Example 3, similarly to Comparative Example 2 illustrated in FIG. 7, the absolute value of the magnetic flux density of the magnetic pole 105R is larger than that of the magnetic pole 104R, and the magnetic influence of the magnetic pole 105R extends to the magnetic pole 104R. Then, the magnetic force Fθ acting on the carrier is positive from upstream of P3, which is a position where the absolute value of the magnetic flux density in the normal direction of the magnetic pole 104R is maximum, in the rotation direction of the developing sleeve 11, to the position where the absolute value of the magnetic flux density in the normal direction of the magnetic pole 105R is maximum.

However, the magnetic influence of the magnetic pole 105R is small on the magnetic pole 103R located upstream of the magnetic pole 104R in the rotation direction of the developing sleeve 11, and the magnetic force Fθ acts in the direction toward the magnetic pole 103R on the carrier on the developing sleeve 11 in the vicinity of P2, which is a position where the absolute value of the magnetic flux density in the normal direction of the magnetic pole 103R is maximum. That is, the magnetic force Fθ is positive upstream of P2 in the rotation direction of the developing sleeve 11, and the magnetic force Fθ is negative downstream of P2 in the rotation direction of the developing sleeve 11. Therefore, the direction of the magnetic force Fθ may coincide with the direction in which the air flows in the flow path AP (the direction of the wind load Fa) in a part of the region TH downstream of P2 in the rotation direction of the developing sleeve 11, and in Comparative Example 3, the carrier is likely to be separated from the developing sleeve 11.

In the present embodiment as well, P2 is a position where the absolute value of the magnetic flux density in the normal direction of the first feeding pole 103 on the developing sleeve 11 is maximum, and P3 is a position where the absolute value of the magnetic flux density in the normal direction of the second feeding pole 104 on the developing sleeve 11 is maximum. In this case, P1 is located downstream of P2 and upstream of P3 in the rotation direction of the developing sleeve 11. Further, P1 is located in a range where the absolute value of the magnetic flux density in the normal direction of the first feeding pole 103 is larger than 0 with respect to the rotation direction of the developing sleeve. That is, the position P1 is arranged in a range where the polarity affects the magnetic flux density of the first feeding pole 103 downstream of P2 in the rotation direction of the developing sleeve 11, that is, in a range where the absolute value of the magnetic flux density in the normal direction of the magnetic pole 103R is positive in the graph of FIG. 8. This is because P1 is disposed such that the duct lower portion 72 covers the vicinity of P2 to prevent a region where the magnetic force Fθ acting on the carrier in the vicinity of the first feeding pole 103 on the developing sleeve 11 is negative from being exposed to the flow path AP, and to suppress separation of the carrier from the developing sleeve 11 in the vicinity of the first feeding pole 103.

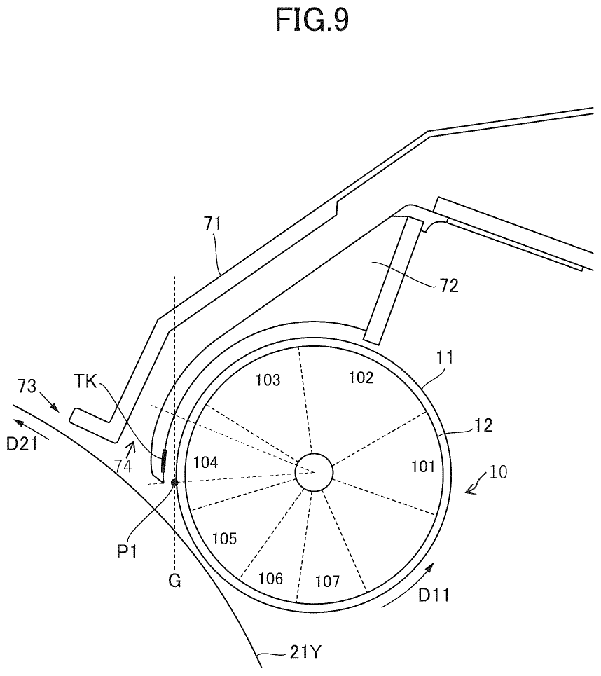

Here, in order to further improve the effect of suppressing the suction of the carrier into the duct 70, it is conceivable to employ a configuration as in Comparative Example 4 illustrated in FIG. 9. In Comparative Example 4, P1 is disposed in the vicinity of the position P2 where the absolute value of the magnetic flux density in the normal direction of the second feeding pole 104 is maximum. However, since the duct lower portion 72 deeply enters a region where a large amount of scattered toner is generated, the scattered toner is deposited on the lower surface of the duct lower portion 72 facing the developing sleeve 11, and the deposited toner TK is generated on the lower surface. The deposited toner TK may fall onto the photosensitive drum 21Y by vibration or its own weight. Then, if the deposited toner TK falls onto the photosensitive drum 21Y, a toner image developed on the photosensitive drum 21Y is disturbed, resulting in a dot-like defective image.

However, if the deposited toner TK falls onto the developing sleeve 11 in the vertical direction by its own weight or vibration, the mass of the deposited toner TK is unraveled on the developing sleeve 11, which may not cause a defective image. Therefore, when a tangent on a side close to the photosensitive drum 21Y (suction port 74 side) among tangents in the vertical direction of the developing sleeve 11 is defined as a vertical line G, P1 is preferably located on a side farther from the photosensitive drum 21Y than the vertical line G in the horizontal direction. That is, P1 is preferably located in a range up to the vertical line G downstream of the position P2, where the absolute value of the magnetic flux density in the normal direction of the first feeding pole 103 is maximum, in the rotation direction of the developing sleeve 11. More preferably, P1 is located in a range where the polarity affects the magnetic flux density of the first feeding pole 103, where the risk of generation of deposited toner TK is low.

In the graph of FIG. 8, P1 is located in a range up to the vertical line G downstream of the position P2, where the absolute value of the magnetic flux density in the normal direction of the magnetic pole 103R is maximum, in the rotation direction of the developing sleeve 11 (P1 is located at approximately 130 degrees). The maximum value (absolute value) of the magnetic flux density in the normal direction of the magnetic pole 103R was 87 mT, the angle at this position P2 was 117 degrees, the maximum value (absolute value) of the magnetic flux density in the normal direction of the magnetic pole 104R was 99 mT, the angle at this position P3 was 181 degrees, the maximum value (absolute value) of the magnetic flux density in the normal direction of the magnetic pole 105R was 171 mT, and the angle at this position was 211 degrees.

In the present specification, “in the vicinity of the developing sleeve 11” or “on the developing sleeve 11” refers to a position 100 μm away from the outer peripheral surface of the developing sleeve 11. That is, the magnetic force acting on the carrier on the developing sleeve 11 is a magnetic force acting on the carrier at a position 100 μm away from the outer peripheral surface of the developing sleeve 11.

In the graph of FIG. 8, the region TH extends from P1 to the vicinity of the magnetic pole 105R downstream in the rotation direction of the developing sleeve 11, and is a region where the developer on the surface of the developing sleeve 11 is exposed to the flow path AP for air when the scattered toner is sucked by the duct 70. In Comparative Example 3 illustrated in FIG. 8, a region where the magnetic force Fθ is negative in this region TH (in a direction that is the same as the direction in which air flows in the flow path AP) exists in a range of about 130 degrees to 150 degrees. This is because the magnetic flux density of the magnetic pole 104R is small on the upstream side in the rotation direction of the developing sleeve 11, and the magnetic influence of the magnetic pole 103R is larger than the magnetic influence of the magnetic pole 104R with respect to the carrier in the vicinity of the magnetic pole 103R, increasing the region where the magnetic force Fθ is negative downstream of P2 in the rotation direction of the developing sleeve 11. Therefore, in this region, as illustrated in FIG. 5A, the force Fs=the wind load Fa+the magnetic force Fθ, and the force Fs becomes larger than the maximum static frictional force Fm, separating the carrier from the developing sleeve 11, so that the carrier is likely to be sucked into the duct 70.

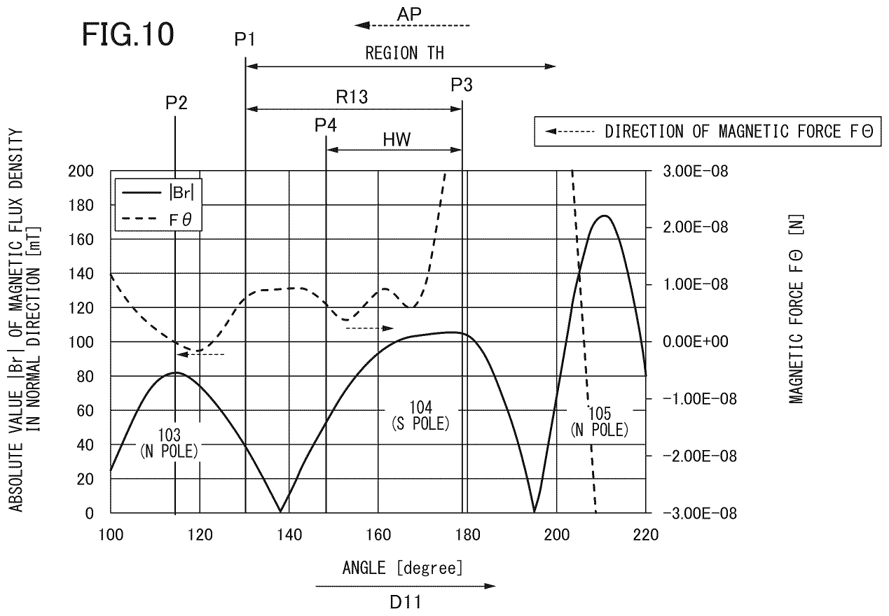

Therefore, in the present embodiment, as will be described below with reference to FIG. 10, when the range from P1 to P3 in the rotation direction of the developing sleeve 11 is defined as R13, the magnetic force in the tangential direction among magnetic forces acting on the carrier on the developing sleeve 11 is defined as Fθ, and the direction of Fθ from P1 to P3 in the rotation direction of the developing sleeve is defined as positive, Fθ≥0 is satisfied in the entire region R13. That is, the developing magnet 12 is configured such that the magnetic force Fθ is positive (in a direction opposite to the direction of air flowing through the flow path AP by the suction of the duct 70) in the entire range R13.

In the present embodiment as well, similarly to Comparative Examples 2 and 3 illustrated in FIGS. 7 and 8 described above, the absolute value of the magnetic flux density of the developing pole 105 is larger than the absolute value of the magnetic flux density of the second feeding pole 104. Therefore, the direction of the magnetic force Fθ in the range from the position P3 included in the region TH to the vicinity of the developing pole 105 downstream in the rotation direction of the developing sleeve 11 is inevitably the same as the rotation direction of the developing sleeve 11 (the direction opposite to the direction of air flowing through the flow path AP by the suction of the duct 70). Therefore, in order to configure the magnetic force Fθ to be positive in the entire region TH, it is required that the magnetic force Fθ be positive within the range R13 from P1 to P3.

To this end, when a point on a side close to P1 among the points on the developing sleeve 11 where the normal component of the magnetic flux density of the second feeding pole 104 takes a half value of the maximum value is defined as P4, and a range from P4 to P3 in the rotation direction of the developing sleeve 11 is defined as HW, the circumferential length on the developing sleeve 11 in the range HW is preferably 40% or more of the circumferential length on the developing sleeve 11 in the range R13. More preferably, the circumferential length on the developing sleeve 11 in the range HW is half or more of the circumferential length on the developing sleeve 11 in the range R13. Hereinafter, for convenience, the circumferential length on the developing sleeve 11 in the range HW may be simply referred to as “HW”, and the circumferential length on the developing sleeve 11 in the range R13 may be simply referred to as “R13”.

That is, in the present embodiment, when the range between the point P4 and the point P3 on the surface of the developing sleeve 11 on the first feeding pole 103 side in the half value of the maximum value of the magnetic flux density of the second feeding pole 104 is defined as HW, the range HW is preferably half or more of the range R13. That is, the developing magnet 12 is configured such that HW/R13≥½.

As a result, this increases the magnetic influence of the second feeding pole 104 on the first feeding pole 103, making it possible to make the magnetic force Fθ acting on the carrier on the developing sleeve 11 positive in the range where the polarity affects the magnetic flux density of the first feeding pole 103 downstream of P1 in the rotation direction of the developing sleeve 11. Therefore, the magnetic force Fθ acts in a direction opposite to the direction of air flowing through the flow path AP in the entire range R13 exposed to the flow path AP. As a result, as illustrated in FIG. 5B, the force Fs=the wind load Fa−the magnetic force Fθ, and the force Fs can be smaller than the maximum static frictional force Fm. Therefore, the separation of the carrier from the developing sleeve 11 can be suppressed, and the suction of the carrier into the duct 70 can be suppressed. In the developing magnet 12, a part in the circumferential direction of the magnet forming the second feeding pole 104 can be cut out, or a magnet having a different magnetic force can be embedded in the cut-out portion, thereby forming an asymmetric magnetic flux density like the second magnetic pole 104.

FIG. 10 illustrates a magnetic characteristic distribution according to the present embodiment. The graph of FIG. 10 shows a distribution of magnetic characteristics acting on the carrier on the developing sleeve 11 in the configuration according to the present embodiment. In the graph, similarly to FIG. 6, the absolute value |Br| of the magnetic flux density is indicated by a solid line, and the magnetic force Fθ acting on the carrier is indicated by a broken line. In the graph of FIG. 10, the angle at P1 was 130 degrees, the maximum value (absolute value) of the magnetic flux density in the normal direction of the first feeding pole 103 was 82 mT, the angle at this position P2 was 115 degrees, the maximum value (absolute value) of the magnetic flux density in the normal direction of the second feeding pole 104 was 105 mT, the angle at this position P3 was 178 degrees, the maximum value (absolute value) of the magnetic flux density in the normal direction of the developing pole 105 was 175 mT, and the angle at this position was 210 degrees.

In addition, the angle range of R13 is 48 degrees, the angle range of HW is 28 degrees, and HW/R13=58%. In the present embodiment, since HW/R13≥½ is satisfied, the magnetic force Fθ is positive in the entire range R13. Therefore, the separation of the carrier from the developing sleeve 11 can be suppressed, thereby suppressing the suction of the carrier into the duct 70.

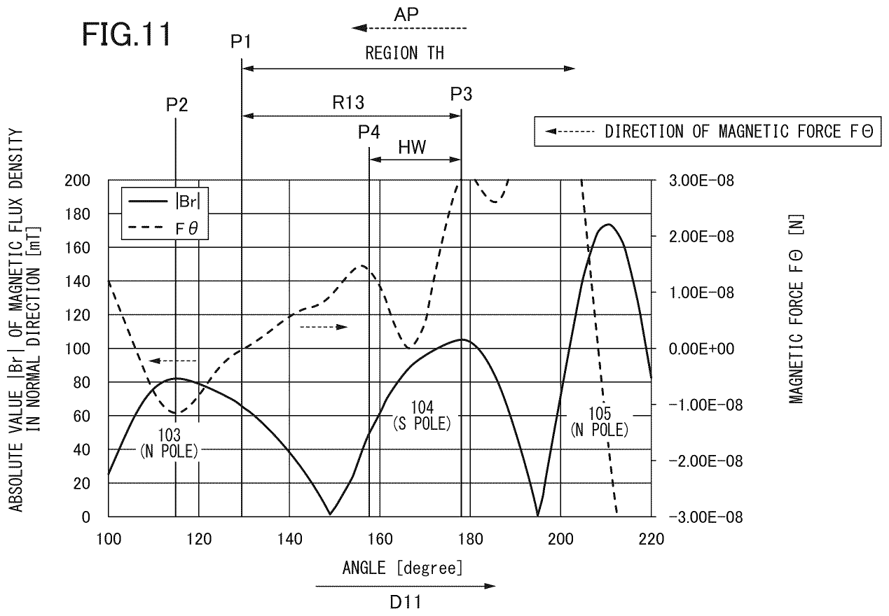

A configuration for comparison with FIG. 10, which is a graph illustrating a configuration according to the present embodiment, will be described with reference to FIG. 8, which is a graph illustrating a configuration according to Comparative Example 3, and FIG. 11, which is a graph illustrating a configuration according to another example of the present embodiment. In FIG. 8, as described above, the angle at P1 was 130 degrees, the maximum value (absolute value) of the magnetic flux density in the normal direction of the magnetic pole 103R was 87 mT, the angle at this position P2 was 117 degrees, the maximum value (absolute value) of the magnetic flux density in the normal direction of the magnetic pole 104R was 99 mT, the angle at this position P3 was 181 degrees, the maximum value (absolute value) of the magnetic flux density in the normal direction of the magnetic pole 105R was 171 mT, and the angle at this position was 211 degrees.

In addition, in the graph of FIG. 8, the angle range of R13 is 51 degrees, the angle range of HW is 17 degrees, HW/R13=33%, and Comparative Example 3 has a configuration that does not satisfy HW/R13≥½. Therefore, since the magnetic force Fθ becomes negative within the range R13, the carrier is likely to be separated from the developing sleeve 11, and the suction of the carrier into the duct 70 cannot be sufficiently suppressed. On the other hand, the present embodiment takes a configuration in which the developing magnet 12 has magnetic field characteristics as illustrated in FIG. 10, making it possible to sufficiently suppress the suction of the carrier into the duct 70, unlike Comparative Example 3.

The graph of FIG. 11 shows a distribution of magnetic characteristics acting on the carrier on the developing sleeve 11 in the configuration according to another example of the present embodiment. In the graph, similarly to FIG. 6, the absolute value |Br| of the magnetic flux density is indicated by a solid line, and the magnetic force Fθ acting on the carrier is indicated by a broken line. In the graph of FIG. 11, the angle at P1 was 130 degrees, the maximum value (absolute value) of the magnetic flux density in the normal direction of the first feeding pole 103 was 82 mT, the angle at this position P2 was 116 degrees, the maximum value (absolute value) of the magnetic flux density in the normal direction of the second feeding pole 104 was 105 mT, the angle at this position P3 was 178 degrees, the maximum value (absolute value) of the magnetic flux density in the normal direction of the developing pole 105 was 175 mT, and the angle at this position was 210 degrees.

In addition, the angle range of R13 is 48 degrees, the angle range of HW is 20 degrees, HW/R13=42%, and another example of the present embodiment has a configuration that does not satisfy HW/R13≥½. However, since HW is a relatively large value and HW/R13≥40% is satisfied, there is no region where the magnetic force Fθ is negative within the range R13. Therefore, the carrier is hardly separated from the developing sleeve 11, thereby making it possible to suppress the suction of the carrier into the duct 70. However, in another example of the present embodiment, a region where the magnetic force Fθ is 0 exists at about 170 degrees, and the force for canceling out the wind load Fa is weak. Therefore, the effect of suppressing the suction of the carrier into the duct 70 by suppressing the separation of the carrier from the developing sleeve 11 is weaker than that in the configuration illustrated in FIG. 10.

Next, Table 1 shows a result of investigating whether or not the carrier is sucked into the duct 70 when R13 and HW are changed by changing the shape and arrangement of magnets forming the first feeding pole 103 and the second feeding pole 104 in the developing magnet 12.

TABLE 1

| | | | | | Minimum value | Whether |
|---|---|---|---|---|---|---|
| | | | | HW/R13 ≥ | Fθmin of magnetic | carrier is |
| | R13 | HW | HW/R13 | ½? | force Fθ in range R13 | sucked |
| Configuration 1 | 51° | 17° | 33% | No | Fθmin < 0 | Poor |
| Configuration 2 | 48° | 14° | 29% | No | Fθmin < 0 | Poor |
| Configuration 3 | 48° | 20° | 42% | No | Fθmin = 0 | Average |
| Configuration 4 | 48° | 24° | 50% | Yes | Fθmin > 0 | Good |
| Configuration 5 | 48° | 28° | 58% | Yes | Fθmin > 0 | Good |
| Configuration 6 | 48° | 30° | 64% | Yes | Fθmin > 0 | Good |

Whether the carrier was sucked was evaluated as follows. 10 solid white images were continuously formed on A3 paper sheets, and the number of carriers adhering to the dust collection filter 84 was checked. When no carrier adhered to the dust collection filter 84 among 10 solid white images formed on A3 paper sheets, 100 solid white images were continuously formed on A3 paper sheets, and the number of carriers adhering to the dust collection filter 84 was checked. The evaluation of carrier suction shown in Table 1 is as follows.
Poor: When 10 images are formed on A3 paper sheets, 10 or more carriers adhere to the dust collection filter 84.
Average: When 10 images are formed on A3 paper sheets, about 1 carrier adheres to the dust collection filter 84.
Good: When 100 images are formed on A3 paper sheets, about 1 carrier adheres to the dust collection filter 84.

When the sign of the minimum value Fθmin of the magnetic force Fθ in the region TH is positive (Fθmin>0), this indicates that the direction of the magnetic force Fθ is opposite to the direction of air flowing through the flow path AP in the entire region TH. On the other hand, when the sign of the minimum value Fθmin of the magnetic force Fθ in the range R13 is negative (Fθmin<0), this indicates that there is a region in which the direction of the magnetic force Fθ coincides with the direction of air flowing through the flow path AP within the range R13. In addition, when the level of the evaluation was equal to or higher than “Average”, it was determined that a target result was obtained regarding suppression of carrier suction.

As is clear from Table 1, in configurations 1 and 2, the ratio of the range HW to the range R13 was significantly smaller than 50%, and accordingly, there was a region where the minimum value Fθmin was negative within the range R13, and the effect of suppressing carrier suction was not observed.

In configuration 3, the ratio of the range HW to the range R13 is 42%, which is smaller than 50% but is close to 50% and is 40% or more, and accordingly, the minimum value Fθmin is not negative and is 0 (Fθmin=0). As a result, a certain degree of effect is exhibited in suppressing carrier suction. However, when the speed of the developing sleeve 11 increases from the viewpoint of high productivity of the image forming apparatus, the centrifugal force applied to the carrier on the developing sleeve 11 increases and the maximum static frictional force Fm decreases, which may cause the carrier to become more likely to be separated from the developing sleeve 11. Therefore, the minimum value Fθmin may be 0 in order to suppress the suction of the carrier into the duct 70, but the minimum value Fθmin is preferably larger than 0 in order to exhibit a higher degree of effect.

In configurations 4, 5, and 6, the ratio of the range HW to the range R13 is larger than 50%. Since the magnetic influence of the second feeding pole 104 also extends to the first feeding pole 103, the magnetic force Fθ is positive in the entire range R13. Then, the magnetic force Fθ acts to cancel out the wind load Fa acting on the carrier on the developing sleeve 11 due to the flow path AP for air generated by the suction of scattered toner by the duct 70, and accordingly, the external force Fs (Fa−Fθ) with respect to the maximum static frictional force of the carrier becomes small. Therefore, the separation of the carrier from the developing sleeve 11 can be suppressed. As a result, in configurations 4, 5, and 6, the suction of the carrier into the duct 70 can be suppressed.

As described above, according to the present embodiment, it is possible to suppress the separation of the carrier from the surface of the developing sleeve 11, which has occurred in the configuration in which the suction port 74 of the duct 70 is disposed in the vicinity of the developing sleeve 11 in order to effectively suck scattered toner. That is, in the developing unit 20Y according to the present embodiment, Fθ≥0 is satisfied in the entire range R13 from P1 to P3. Preferably, the magnetic flux densities of the plurality of magnetic poles stationarily arranged in the developing magnet 12 are set to satisfy HW/R13≥½ such that the direction of the magnetic force Fθ is opposite to the direction of the flow path AP for air sucked into the duct 70, that is, Fθ≥0. Then, the magnetic force Fθ acts on the carrier on the developing sleeve 11 so as to cancel out the wind load Fa caused by the flow path AP for air, and the force Fs, which is a resultant force of the wind load Fa and the magnetic force Fθ, becomes smaller than the maximum static frictional force Fm of the carrier, thereby making it possible to suppress the separation of the carrier from the developing sleeve 11 and suppress the suction of the carrier into the duct 70.

### Second Embodiment

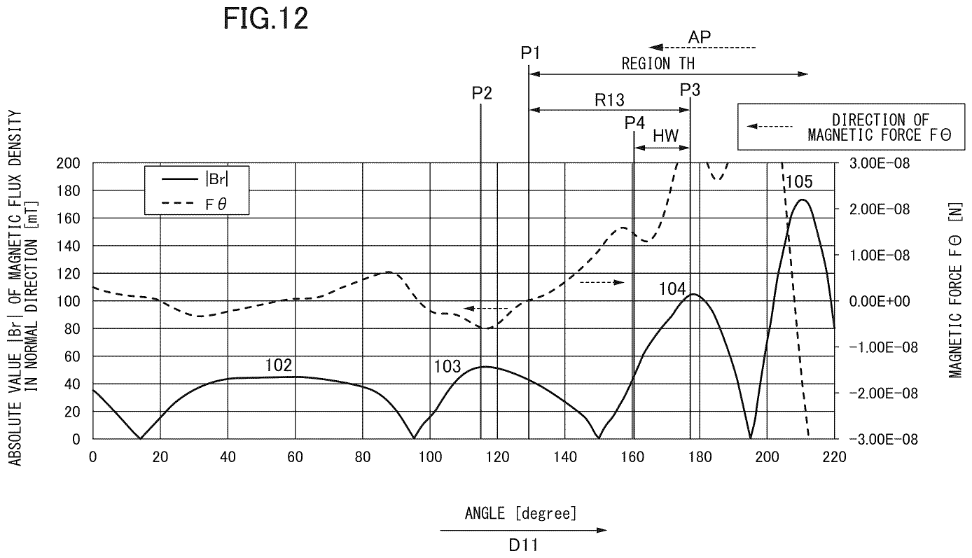

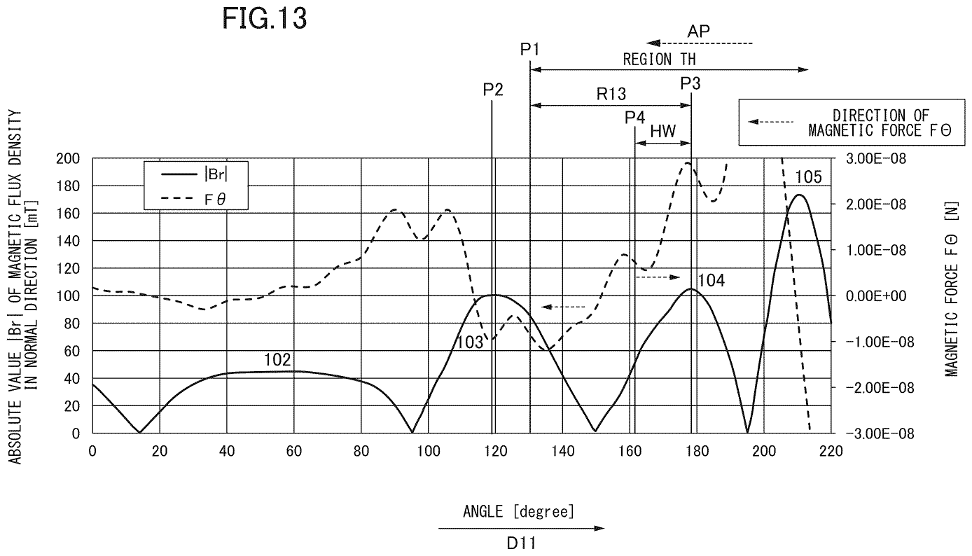

A second embodiment will be described with reference to FIGS. 12 and 13. The present embodiment is different from the first embodiment in the magnetic flux densities of the plurality of magnetic poles stationarily arranged in the developing magnet 12. Since the other configurations and operations are similar to those in the first embodiment described above, the same configurations are denoted by the same reference signs, description and illustration thereof are omitted or simplified, and hereinafter, differences from the first embodiment will be mainly described.

As described above in the first embodiment, the magnetic influence between the adjacent magnetic poles depends on the magnitude relationship between the magnetic flux densities thereof. Therefore, in order to make the direction of the magnetic force Fθ in the entire range R13 opposite to the direction of the flow path AP for air through the duct 70 (the direction that is the same as the rotation direction D11 of the developing sleeve 11), it is effective to make the maximum value of the absolute value of the magnetic flux density in the normal direction of the first feeding pole 103 relatively smaller than the maximum value of the absolute value of the magnetic flux density in the normal direction of the second feeding pole 104. However, if the maximum value of the absolute value of the magnetic flux density in the normal direction of the first feeding pole 103 is smaller than the maximum value of the absolute value of the magnetic flux density in the normal direction of the cut pole 102, the magnetic force Fθ in a direction from the cut pole 102 toward the first feeding pole 103 decreases, and the developer coating on the developing sleeve 11 by the regulating blade 43 becomes uneven. Therefore, the maximum value of the absolute value of the magnetic flux density in the normal direction of the first feeding pole 103 is set to be larger than the maximum value of the absolute value of the magnetic flux density in the normal direction of the cut pole 102.

In the present embodiment, when the maximum value of the absolute value of the magnetic flux density in the normal direction of the cut pole 102 is defined as Bc, the maximum value of the absolute value of the magnetic flux density in the normal direction of the first feeding pole 103 is defined as B1, the maximum value of the absolute value of the magnetic flux density in the normal direction of the second feeding pole 104 is defined as B2, and the average value of Bc and B2 is defined as Bh=(Bc+B2)/2, Bh≥B1>Bc is satisfied, and HW/R13≥¼ is satisfied. This makes it possible to increase the magnetic influence of the second feeding pole 104 on the carrier on the developing sleeve 11 in the vicinity of the first feeding pole 103. As a result, the sign of the magnetic force Fθ can be positive in the entire range R13. That is, since the direction of the magnetic force Fθ is opposite to the direction of the flow path AP for air through the duct 70, the separation of the carrier from the developing sleeve 11 can be suppressed in the range R13, and the suction of the carrier into the duct 70 can be suppressed.

The graph of FIG. 12 shows a distribution of magnetic characteristics acting on the carrier on the developing sleeve 11 in the configuration according to the present embodiment. In the graph, similarly to FIG. 6, the absolute value |Br| of the magnetic flux density is indicated by a solid line, and the magnetic force Fθ acting on the carrier is indicated by a broken line. In the graph of FIG. 12, the angle at P1 was set to 130 degrees, Bc was set to 45 mT, the angle at the position of the maximum value of the absolute value of the magnetic flux density in the normal direction of the cut pole 102 was set to 59 degrees, B2 was set to 105 mT, and the angle at the position P3 of the maximum value of the absolute value of the magnetic flux density in the normal direction of the second feeding pole 104 was set to 178 degrees. In the present embodiment, since Bh=75 mT, the magnetic characteristics are shown in which B1 is set to 52 mT and the angle at the position P2 of the maximum value of the absolute value of the magnetic flux density in the normal direction of the first feeding pole 103 is set to 115 degrees so as to satisfy Bh>B1. In addition, the maximum value of the absolute value of the magnetic flux density in the normal direction of the developing pole 105 was 175 mT, and the angle at that position was 210 degrees.

In the present embodiment, the angle range of R13 is 48 degrees, the angle range of HW is 16 degrees, HW/R13=33%, and HW/R13≥¼ is satisfied. In such a configuration, it was confirmed that the magnetic force Fθ was positive in the entire region R13. As a result, the separation of the carrier from the developing sleeve 11 can be suppressed, thereby suppressing the suction of the carrier into the duct 70.

A configuration for comparison with FIG. 12, which is a graph illustrating a configuration according to the present embodiment, will be described with reference to FIG. 13, which is a graph illustrating a configuration according to Comparative Example 5. The graph of FIG. 13 shows a distribution of magnetic characteristics acting on the carrier on the developing sleeve 11 in the configuration according to Comparative Example 5. In the graph, similarly to FIG. 6, the absolute value |Br| of the magnetic flux density is indicated by a solid line, and the magnetic force Fθ acting on the carrier is indicated by a broken line. In the graph of FIG. 13, the angle at P1 was set to 130 degrees, Bc was set to 45 mT, the angle at the position of the maximum value of the absolute value of the magnetic flux density in the normal direction of the cut pole 102 was set to 59 degrees, B2 was set to 105 mT, and the angle at the position P3 of the maximum value of the absolute value of the magnetic flux density in the normal direction of the second feeding pole 104 was set to 178 degrees.

In Comparative Example 5, Bh=75 mT is satisfied, but B1 is set to 100 mT, and the angle at the position P2 of the maximum value of the absolute value of the magnetic flux density in the normal direction of the first feeding pole 103 is set to 118 degrees, thereby indicating magnetic characteristics that do not satisfy Bh>B1. The maximum value of the absolute value of the magnetic flux density in the normal direction of the developing pole 105 was 175 mT, and the angle at that position was 210 degrees. In Comparative Example 5, the angle range of R13 is 48 degrees, the angle range of HW is 16 degrees, and HW/R13=33%.

In such a configuration according to Comparative Example 5, since the magnetic influence of the second feeding pole 104 on the first feeding pole 103 decreases, the magnetic force Fθ becomes negative in a range where the polarity affects the magnetic flux density of the first feeding pole 103. Therefore, the magnetic force Fθ acts on the carrier on the developing sleeve 11 in the same direction as the wind load Fa, and accordingly, the force Fs (Fs=Fa+Fθ) opposing the maximum static frictional force Fm of the carrier increases. As a result, the separation of the carrier from the developing sleeve 11 cannot be sufficiently suppressed, and the suction of the carrier into the duct 70 cannot be suppressed.

As described above, in both the configuration of FIG. 12 according to the present embodiment and the configuration of FIG. 13 according to Comparative Example 5, HW/R13 is 33%, but the magnetic influence of the second feeding pole 104 on the first feeding pole 103 is different depending on whether the maximum value B1 of the magnetic flux density in the normal direction of the first feeding pole 103 satisfies Bh≥B1>Bc, and thus, the direction of the magnetic force Fθ in the range R13 is different.

Next, Table 2 shows a result of investigating whether the carrier is sucked into the duct 70 when Bc, B1, B2, R13, and HW are changed by changing the shape and arrangement of magnets forming the cut pole 102, the first feeding pole 103, and the second feeding pole 104 in the developing magnet 12.

TABLE 2

| | | | | | | | | | HW/ | Minimum value | Whether |
|---|---|---|---|---|---|---|---|---|---|---|---|
| | (B2 + Bc)/ | | | | Bh ≥ | | | HW/ | R13 ≥ | Fθmin of magnetic | carrier |
| | 2 = Bh | | B1 | | B1? | R13 | HW | R13 | ¼? | force Fθ in range R13 | is sucked |
| Configuration 11 | 75 | mT | 52 | mT | Yes | 48° | 10° | 21% | No | Fθmin < 0 | Poor |
| Configuration 12 | 64 | mT | 52 | mT | Yes | 51° | 12° | 24% | No | Fθmin < 0 | Poor |
| Configuration 13 | 73.5 | mT | 73.5 | mT | Yes | 48° | 12° | 23% | No | Fθmin < 0 | Poor |
| Configuration 14 | 75 | mT | 101 | mT | No | 48° | 17° | 35% | Yes | Fθmin < 0 | Poor |
| Configuration 15 | 73.5 | mT | 81 | mT | No | 48° | 24° | 50% | Yes | Fθmin < 0 | Poor |
| Configuration 16 | 64 | mT | 52 | mT | Yes | 48° | 12° | 25% | Yes | Fθmin > 0 | Good |
| Configuration 17 | 64 | mT | 52 | mT | Yes | 48° | 22° | 46% | Yes | Fθmin > 0 | Good |
| Configuration 18 | 75 | mT | 52 | mT | Yes | 48° | 16° | 33% | Yes | Fθmin > 0 | Good |
| Configuration 19 | 73.5 | mT | 52 | mT | Yes | 48° | 22° | 46% | Yes | Fθmin > 0 | Good |
| Configuration 20 | 73.5 | mT | 52 | mT | Yes | 48° | 24° | 50% | Yes | Fθmin > 0 | Good |
| Configuration 21 | 73.5 | mT | 73.5 | mT | Yes | 48° | 24° | 50% | Yes | Fθmin > 0 | Good |

Whether the carrier is sucked is evaluated in the same manner as described in the first embodiment. In addition, when the minimum value Fθmin of the magnetic force Fθ in the range R13 is positive (Fθmin>0), this indicates that the direction of the magnetic force Fθ is opposite to the direction of air flowing through the flow path AP in the entire range R13. On the other hand, when the minimum value Fθmin of the magnetic force Fθ in the range R13 is negative (Fθmin<0), this indicates that there is a region in which the direction of the magnetic force Fθ coincides with the direction of air flowing through the flow path AP within the range R13. In addition, when the level of the evaluation was equal to or higher than “Average”, it was determined that a target result was obtained regarding suppression of carrier suction.

As is clear from Table 2, in configurations 11 to 15, the effect of suppressing the suction of the carrier into the duct 70 was low. In configurations 11, 12, and 13, in the half value of the maximum value B2 of the magnetic flux density in the normal direction of the second feeding pole 104, since the width on the upstream side in the rotation direction of the developing sleeve 11 was narrow, and the magnetic influence on the first feeding pole 103 was small, there was a region where the minimum value Fθmin was negative. Further, in configurations 14 and 15, since the maximum value B1 of the magnetic flux density in the normal direction of the first feeding pole 103 was relatively larger than the maximum value B2 of the magnetic flux density in the normal direction of the second feeding pole 104, the magnetic influence of the second feeding pole 104 on the first feeding pole 103 decreased, there was a region where the minimum value Fθmin was negative. In this manner, in configurations 11 to 15, since the magnetic force Fθ acts on the carrier on the developing sleeve 11 in the same direction as the wind load Fa within the range R13, the force Fs (Fs=Fa+Fθ) opposing the maximum static frictional force Fm of the carrier becomes large, and as a result, the separation of the carrier from the developing sleeve 11 cannot be sufficiently suppressed, and the suction of the carrier into the duct 70 cannot be suppressed.

In configurations 16 to 21, the minimum value Fθmin of the magnetic force Fθ in the range R13 is positive. Therefore, since the magnetic force Fθ acted on the carrier in the direction opposite to the wind load Fa in the entire range R13, the force Fs (Fs=Fa−Fθ) opposing the maximum static frictional force Fm of the carrier became small, and as a result, the effect of suppressing the separation of the carrier from the developing sleeve 11 and suppressing the suction of the carrier into the duct 70 was observed.

In configurations 16 and 17, the magnitude of B1 relative to Bh was the same, and the ratio of HW to R13 was different, while both satisfied Bh≥B1 and HW/R13≥¼, so the magnetic influence of the second feeding pole 104 on the first feeding pole 103 was large, and the minimum value Fθmin was positive in the entire range R13. When comparing configuration 12 with configurations 16 and 17, configuration 12 is the same as configurations 16 and 17 in the magnitude of B1 relative to Bh. However, configuration 12 does not satisfy HW/R13≥¼. Therefore, in configuration 12, the magnetic influence of the second feeding pole 104 on the first feeding pole 103 was small, and as a result, there was a region where the minimum value Fθmin was negative.

Similarly, in configurations 19 and 20, the magnitude of B1 relative to Bh is the same, and the ratio of HW to R13 is different, while both satisfy Bh≥B1 and HW/R13≥¼. Therefore, in configurations 19 and 20, the magnetic influence of the second feeding pole 104 on the first feeding pole 103 was large, and the minimum value Fθmin was positive in the entire range R13. When comparing configuration 11 with configurations 19 and 20, configuration 11 is generally the same as configurations 19 and 20 in the magnitude of B1 relative to Bh, but configuration 11 does not satisfy HW/R13≥¼. Therefore, in configuration 11, the magnetic influence of the second feeding pole 104 on the first feeding pole 103 was small, and as a result, there was a region where the minimum value Fθmin was negative.

When comparing configurations 20 and 21, the ratio of HW to R13 is the same, and HW/R13≥¼ is satisfied in both configurations. The magnitude of B1 relative to Bh is different, while both satisfy Bh≥B1. Therefore, in configurations 20 and 21, the magnetic influence of the second feeding pole 104 on the first feeding pole 103 was large, and the minimum value Fθmin was positive in the entire range R13.

When comparing configuration 13 with configuration 21, the magnitude of B1 relative to Bh is Bh=B1, and Bh≥B1 is satisfied in both configurations. However, configuration 13 does not satisfy the condition of HW/R13≥¼. Therefore, in configuration 13, the magnetic influence of the second feeding pole 104 on the first feeding pole 103 was small, and as a result, there was a region where the minimum value Fθmin was negative in the range R13. That is, even if Bh≥B1 is satisfied, whether the minimum value Fθmin is positive or negative in the range R13 changes depending on whether HW/R13≥¼ is satisfied.

As described above, according to the present embodiment, it is possible to suppress the separation of the carrier from the surface of the developing sleeve 11, which has occurred in the configuration in which the suction port 74 of the duct 70 is disposed in the vicinity of the developing sleeve 11 in order to effectively suck scattered toner. That is, in the developing unit 20Y according to the present embodiment, in the entire range R13 from P1 to P3, the magnetic flux densities of the plurality of magnetic poles stationarily arranged in the developing magnet 12 are set to satisfy Bh≥B1 and HW/R13≥¼ such that the direction of the magnetic force Fθ is opposite to the direction of the flow path AP for air sucked into the duct 70, that is, Fθ≥0. Then, the magnetic force Fθ acts on the carrier on the developing sleeve 11 so as to cancel out the wind load Fa caused by the flow path AP for air, and therefore, the force Fs, which is a resultant force of the wind load Fa and the magnetic force Fθ, becomes smaller than the maximum static frictional force Fm of the carrier, thereby making it possible to suppress the separation of the carrier from the developing sleeve 11 and suppress the suction of the carrier into the duct 70.

In the present embodiment as well, as in the first embodiment, it is preferable to satisfy HW/R13≥40%, and it is more preferable to satisfy HW/R13≥½.

### OTHER EMBODIMENTS

The present disclosure is not limited to the configurations of the embodiments described above. For example, the image forming apparatus 100 is not limited to the MFP, and may be a copying machine, a printer, or a facsimile machine. In addition, the configurations of the first screw 41 and the second screw 42 are not particularly limited as long as the developer can be fed, and for example, a spiral blade or a paddle-shaped blade can be applied.

According to the present disclosure, it is possible to suppress the suction of the carrier into the duct portion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196680, filed Nov. 11, 2024, which is hereby incorporated by reference herein in its entirety.

What is claimed is:

1. A developing unit comprising:
a developer container configured to contain a developer including toner and carrier;
a rotatable developing member configured to carry and feed the developer to a developing position where an electrostatic latent image formed on an image bearing member is developed;
a regulating portion configured to regulate an amount of developer carried on an outer peripheral surface of the rotatable developing member;
a magnet provided non-rotatably and stationarily inside the rotatable developing member, the magnet including:
a regulating pole disposed to face the regulating portion;
a first feeding pole disposed downstream of the regulating pole in a rotation direction of the rotatable developing member;
a second feeding pole disposed adjacent to the first feeding pole and downstream of the first feeding pole in the rotation direction of the rotatable developing member, and having a polarity different from that of the first feeding pole; and
a developing pole disposed downstream of the second feeding pole in the rotation direction of the rotatable developing member, and facing the image bearing member at the developing position; and
a duct portion including:
a suction port that is an inlet through which the developer scattered in the developer container is sucked, and extending upstream in the rotation direction of the rotatable developing member from the suction port;
a first duct wall disposed to face the rotatable developing member; and
a second duct wall disposed to face the rotatable developing member and face the first duct wall, and configured to form a space between the second duct wall and the first duct wall through which the developer sucked from the suction port flows, the second duct wall being located outside the first duct wall with respect to a rotation center of the rotatable developing member in a radial direction of the rotatable developing member,
wherein in the rotation direction of the rotatable developing member, the suction port is located upstream of a point on the outer peripheral surface of the rotatable developing member at which an absolute value of a magnetic flux density of the developing pole in a normal direction with respect to the outer peripheral surface of the rotatable developing member becomes a maximum value and downstream of a point on the outer peripheral surface of the rotatable developing member at which an absolute value of a magnetic flux density of the regulating pole in the normal direction with respect to the outer peripheral surface of the rotatable developing member becomes a maximum value,
P1 is located downstream of P2 and upstream of P3 in the rotation direction of the rotatable developing member, where
P1 is a point at which a line connecting the rotation center of the rotatable developing member and a distal end of the first duct wall on a suction port side intersects the outer peripheral surface of the rotatable developing member,
P2 is a point on the outer peripheral surface of the rotatable developing member at which an absolute value of a magnetic flux density of the first feeding pole in the normal direction with respect to the outer peripheral surface of the rotatable developing member becomes a maximum value, and
P3 is a point on the outer peripheral surface of the rotatable developing member at which an absolute value of a magnetic flux density of the second feeding pole in the normal direction with respect to the outer peripheral surface of the rotatable developing member becomes a maximum value, and
wherein
Fθ≥0 is satisfied over a range from P1 to P3 in the rotation direction of the rotatable developing member, where
Fθ is a magnetic force in a tangential direction with respect to the outer peripheral surface of the rotatable developing member in a magnetic force acting on the carrier on the outer peripheral surface of the rotatable developing member, and
a direction of Fθ from P1 toward P3 in the rotation direction of the rotatable developing member is defined as positive.

2. The developing unit according to claim 1, wherein
a circumferential length of the rotatable developing member in a range from P4 to P3 in the rotation direction of the rotatable developing member is 40% or more of a circumferential length of the rotatable developing member in the range from P1 to P3 in the rotation direction of the rotatable developing member, P4 being a point on a side closer to P1 among points on the outer peripheral surface of the rotatable developing member at which the absolute value of the magnetic flux density of the second feeding pole in the normal direction with respect to the outer peripheral surface of the rotatable developing member becomes a half value of the maximum value.

3. The developing unit according to claim 1, wherein
a circumferential length of the rotatable developing member in a range from P4 to P3 in the rotation direction of the rotatable developing member is half or more of a circumferential length of the rotatable developing member in the range from P1 to P3 in the rotation direction of the rotatable developing member, P4 being a point on a side closer to P1 among points on the outer peripheral surface of the rotatable developing member at which the absolute value of the magnetic flux density of the second feeding pole in the normal direction with respect to the outer peripheral surface of the rotatable developing member becomes a half value of the maximum value.

4. The developing unit according to claim 1, wherein
(Bc+B2)/2≥B1>Bc is satisfied, where
Bc is the maximum value of the absolute value of the magnetic flux density of the regulating pole in the normal direction with respect to the outer peripheral surface of the rotatable developing member,
B1 is the maximum value of the absolute value of the magnetic flux density of the first feeding pole in the normal direction with respect to the outer peripheral surface of the rotatable developing member, and
B2 is the maximum value of the absolute value of the magnetic flux density of the second feeding pole in the normal direction with respect to the outer peripheral surface of the rotatable developing member, and
wherein
a circumferential length of the rotatable developing member in a range from P4 to P3 in the rotation direction of the rotatable developing member is ¼ or more of a circumferential length of the rotatable developing member in the range from P1 to P3 in the rotation direction of the rotatable developing member, where
P4 is a point on a side closer to P1 among points on the outer peripheral surface of the rotatable developing member at which the absolute value of the magnetic flux density of the second feeding pole in the normal direction with respect to the outer peripheral surface of the rotatable developing member becomes a half value of the maximum value.

5. The developing unit according to claim 1, wherein
in the rotation direction of the rotatable developing member, P1 is located in a range where the absolute value of the magnetic flux density of the first feeding pole in the normal direction with respect to the outer peripheral surface of the rotatable developing member is larger than 0.

6. The developing unit according to claim 1, wherein
the point P1 is located on a side farther from the image bearing member than a vertical line G in a horizontal direction, the vertical line G being a tangent on a side close to the image bearing member among tangents in a vertical direction of the rotatable developing member.

7. The developing unit according to claim 1, wherein
the second duct wall extends downstream of the distal end of the first duct wall on the suction port side in the rotation direction of the rotatable developing member.

8. The developing unit according to claim 1, wherein
the image bearing member is configured to be rotatable, and
where at a position where the rotatable developing member and the image bearing member face each other, the rotation direction of the rotatable developing member is opposite to a rotation direction of the image bearing member.

9. A developing unit comprising:
a developer container configured to contain a developer including toner and carrier;
a rotatable developing member configured to carry and feed the developer to a developing position where an electrostatic latent image formed on an image bearing member is developed;
a regulating portion configured to regulate an amount of developer carried on an outer peripheral surface of the rotatable developing member;
a magnet provided non-rotatably and stationarily inside the rotatable developing member, the magnet including:
a regulating pole disposed to face the regulating portion;
a first feeding pole disposed downstream of the regulating pole in a rotation direction of the rotatable developing member;
a second feeding pole disposed adjacent to the first feeding pole and downstream of the first feeding pole in the rotation direction of the rotatable developing member, and having a polarity different from that of the first feeding pole; and
a developing pole disposed downstream of the second feeding pole in the rotation direction of the rotatable developing member, and facing the image bearing member at the developing position; and
a duct portion including:
a suction port that is an inlet through which the developer scattered in the developer container is sucked, and extending upstream in the rotation direction of the rotatable developing member from the suction port;
a first duct wall disposed to face the rotatable developing member; and
a second duct wall disposed to face the rotatable developing member and face the first duct wall, and configured to form a space between the second duct wall and the first duct wall through which the developer sucked from the suction port flows, the second duct wall being located outside the first duct wall with respect to a rotation center of the rotatable developing member in a radial direction of the rotatable developing member,
wherein in the rotation direction of the rotatable developing member, the suction port is located upstream of a point on the outer peripheral surface of the rotatable developing member at which an absolute value of a magnetic flux density of the developing pole in a normal direction with respect to the outer peripheral surface of the rotatable developing member becomes a maximum value and downstream of a point on the outer peripheral surface of the rotatable developing member at which an absolute value of a magnetic flux density of the regulating pole in the normal direction with respect to the outer peripheral surface of the rotatable developing member becomes a maximum value,
wherein P1 is located downstream of P2 and upstream of P3 in the rotation direction of the rotatable developing member, where
P1 is a point at which a line connecting the rotation center of the rotatable developing member and a distal end of the first duct wall on a suction port side intersects the outer peripheral surface of the rotatable developing member,
P2 being a point on the outer peripheral surface of the rotatable developing member at which an absolute value of a magnetic flux density of the first feeding pole in the normal direction with respect to the outer peripheral surface of the rotatable developing member becomes a maximum value, and
P3 being a point on the outer peripheral surface of the rotatable developing member at which an absolute value of a magnetic flux density of the second feeding pole in the normal direction with respect to the outer peripheral surface of the rotatable developing member becomes a maximum value, and
wherein (Bc+B2)/2>B1>Bc is satisfied, where
Bc is the maximum value of the absolute value of the magnetic flux density of the regulating pole in the normal direction with respect to the outer peripheral surface of the rotatable developing member,
B1 is the maximum value of the absolute value of the magnetic flux density of the first feeding pole in the normal direction with respect to the outer peripheral surface of the rotatable developing member,
B2 is the maximum value of the absolute value of the magnetic flux density of the second feeding pole in the normal direction with respect to the outer peripheral surface of the rotatable developing member, and
wherein a circumferential length of the rotatable developing member in a range from P4 to P3 in the rotation direction of the rotatable developing member is ¼ or more of a circumferential length of the rotatable developing member in the range from P1 to P3 in the rotation direction of the rotatable developing member, where
P4 is a point on a side closer to P1 among points on the outer peripheral surface of the rotatable developing member at which the absolute value of the magnetic flux density of the second feeding pole in the normal direction with respect to the outer peripheral surface of the rotatable developing member becomes a half value of the maximum value.

10. The developing unit according to claim 9, wherein
the circumferential length of the rotatable developing member in the range from P4 to P3 in the rotation direction of the rotatable developing member is 40% or more of the circumferential length of the rotatable developing member in the range from P1 to P3 in the rotation direction of the rotatable developing member.

11. The developing unit according to claim 9, wherein
the circumferential length of the rotatable developing member in the range from P4 to P3 in the rotation direction of the rotatable developing member is half or more of the circumferential length of the rotatable developing member in the range from P1 to P3 in the rotation direction of the rotatable developing member.

12. The developing unit according to claim 9, wherein
in the rotation direction of the rotatable developing member, P1 is located in a range where the absolute value of the magnetic flux density of the first feeding pole in the normal direction with respect to the outer peripheral surface of the rotatable developing member is larger than 0.

13. The developing unit according to claim 9, wherein
the point P1 is located on a side farther from the image bearing member than a vertical line G in a horizontal direction, the vertical line G being a tangent on a side close to the image bearing member among tangents in a vertical direction of the rotatable developing member.

14. The developing unit according to claim 9, wherein
the second duct wall extends downstream of the distal end of the first duct wall on the suction port side in the rotation direction of the rotatable developing member.

15. The developing unit according to claim 9,
wherein the image bearing member is configured to be rotatable, and
wherein at a position where the rotatable developing member and the image bearing member face each other, the rotation direction of the rotatable developing member is opposite to a rotation direction of the image bearing member.
